(19) United States
(12) Patent Application Publication
(10) Pub. No.: US 2024/0028050 A1
(43) Pub. Date: Jan. 25, 2024

(54) CONTROLLING AN AUTONOMOUS VEHICLE AND THE SERVICE SELECTION OF AN AUTONOMOUS VEHICLE

(71) Applicant: Uber Technologies, Inc., San Francisco, CA (US)

(72) Inventors: Brent Goldman, San Francisco, CA (US); Leigh Hagestad, San Francisco, CA (US); Matthew James Way, San Francisco, CA (US)

(21) Appl. No.: 18/481,015

(22) Filed: Oct. 4, 2023

Related U.S. Application Data
(63) Continuation of application No. 16/381,839, filed on Apr. 11, 2019.
(60) Provisional application No. 62/729,087, filed on Sep. 10, 2018.
(60) Provisional application No. 62/656,143, filed on Apr. 11, 2018.

(51) Int. Cl. G05D 1/02; G06Q 10/02; G06Q 50/30; G08G 1/00

(52) U.S. Cl. CPC G05D 1/0297; G06Q 10/02; G06Q 50/30; G08G 1/202

(57) ABSTRACT

Systems and methods for controlling an autonomous vehicle and the service selection for an autonomous vehicle are provided. In one example embodiment, a computing system can obtain data indicative of a plurality of plurality of service entities. The computing system can determine a first service entity of the plurality of service entities for which an autonomous vehicle is to perform a first vehicle service. The computing system can indicate that the autonomous vehicle is available to perform the first vehicle service for the first service entity. In some implementations, this indication can be done while the autonomous vehicle is already providing a vehicle service. The computing system can obtain data indicative of a vehicle service assignment associated with the first service entity and cause the vehicle to travel accordingly. In some implementations, the computing system can select a vehicle service assignment from among a plurality of different vehicle service assignments.

### PRIORITY CLAIM

The present application is a continuation of U.S. application Ser. No. 16/381,839, filed Apr. 11, 2019, which is based on and claims priority to U.S. Provisional Application 62/656,143 having a filing date of Apr. 11, 2018 and U.S. Provisional Application 62/729,087 having a filing date of Sep. 10, 2018, each of which are incorporated by reference herein.

### CROSS-REFERENCE TO RELATED APPLICATION

The present application relates to U.S. application Ser. No. 16/381,844, filed Apr. 11, 2019 and U.S. application Ser. No. 16/381,847, filed Apr. 11, 2019, each of which are incorporated by reference herein.

### FIELD

The present disclosure relates generally to controlling autonomous vehicles and the selection of the vehicle services performed by the autonomous vehicles, for example based on the ability of the autonomous vehicle to perform the service.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for controlling autonomous vehicles. The method includes obtaining, by a computing system that includes one or more computing devices, data associated with a plurality of service entities. Each service entity is associated with a provision of one or more vehicle services. The method includes determining, by the computing system and based at least in part on the data associated with the plurality of service entities, a first service entity of the plurality of service entities for which an autonomous vehicle is to perform a first vehicle service. The method includes indicating, by the computing system to a remote computing system associated with the first service entity, that the autonomous vehicle is available to perform the first vehicle service for the first service entity. The method includes obtaining, by the computing system, data indicative of a vehicle service assignment associated with the first service entity. The vehicle service assignment is indicative of the first vehicle service.

Another example aspect of the present disclosure is directed to a computing system. The computing system includes one or more processors and one or more tangible, non-transitory, computer readable media that collectively store instructions that when executed by the one or more processors cause the computing system to perform operations. The operations include determining a first service entity, of a plurality of service entities, for which an autonomous vehicle is to perform at least one first vehicle service. The operations include indicating, to a first remote computing system associated with the first service entity, that the autonomous vehicle is available to perform the at least one first vehicle service for the first service entity. The operations include obtaining data indicative of at least one first vehicle service assignment associated with the first service entity. The at least one first vehicle service assignment is indicative of the at least one first vehicle service.

Yet another example aspect of the present disclosure is directed to an autonomous vehicle. The autonomous vehicle one or more processors and one or more tangible, non-transitory, computer readable media that collectively store instructions that when executed by the one or more processors cause the one or more processors to perform operations. The operations include obtaining data associated with one or more service entities of a plurality of service entities. The operations include determining a first service entity for which the autonomous vehicle is to perform one or more first vehicle services based at least in part on the data associated with the one or more service entities. The operations include establishing a first communication session with a first remote computing system associated with the first service entity. The operations include obtaining, via the first communication session, data indicative of a first vehicle service assignment associated with the first service entity. The operations include initiating a first motion control for the autonomous vehicle in accordance with the first vehicle service assignment.

One example aspect of the present disclosure is directed to a computer-implemented method for controlling autonomous vehicles. The method includes obtaining, by a computing system that includes one or more computing devices, data associated with a plurality of candidate vehicle service assignments. Each of the candidate vehicle service assignments is associated with a different service entity of a plurality of service entities. The method includes determining, by the computing system, a selected vehicle service assignment based at least in part on the data associated with the plurality of candidate vehicle service assignments. The method includes communicating, by the computing system, data indicative of an acceptance of the selected vehicle service assignment to a remote computing system associated with the service entity that is associated with the selected vehicle service assignment. The method includes causing, by the computing system, the autonomous vehicle to initiate a motion control in accordance with the selected vehicle service assignment.

Another example aspect of the present disclosure is directed to a computing system. The computing system includes one or more processors and one or more tangible, non-transitory, computer readable media that collectively store instructions that when executed by the one or more processors cause the computing system to perform operations. The operations include indicating to a plurality of service entities that an autonomous vehicle is available to perform one or more vehicle services. The operations include obtaining data associated with a plurality of candidate vehicle service assignments. Each of the candidate vehicle service assignments is associated with a different service entity of the plurality of service entities. The operations include determining a selected vehicle service assignment based at least in part on the data associated with the plurality of candidate vehicle service assignments. The operations include communicating data indicative of an acceptance of the selected vehicle service assignment. The operations include causing the autonomous vehicle to initiate a motion control in accordance with the selected vehicle service assignment.

Yet another example aspect of the present disclosure is directed to an autonomous vehicle. The autonomous vehicle includes one or more processors and one or more tangible, non-transitory, computer readable media that collectively store instructions that when executed by the one or more processors cause the one or more processors to perform operations. The operations include obtaining data associated with a plurality of candidate vehicle service assignments. Each of the candidate vehicle service assignments is associated with a different service entity of a plurality of service entities. Each of the candidate vehicle service assignments includes a request for the autonomous vehicle to perform one or more vehicle services associated with the respective service entity. The operations include determining a selected vehicle service assignment based at least in part on the data associated with the plurality of candidate vehicle service assignments. The operations include initiating a motion control for the autonomous vehicle in accordance with the selected vehicle service assignment.

One example aspect of the present disclosure is directed to a computer-implemented method for autonomous vehicle communication. The method includes obtaining, by a computing system that includes one or more computing devices, data associated with a status of an autonomous vehicle. The method includes determining, by the computing system, that the autonomous vehicle is to become available to perform one or more vehicle services at a later time based at least in part on the data associated with the status of the autonomous vehicle. The method includes indicating, by the computing system, to a plurality of service entities that the autonomous vehicle is to become available to perform the one or more vehicle services.

Another example aspect of the present disclosure is directed to a computing system. The computing system includes one or more processors and one or more tangible, non-transitory, computer readable media that store instructions that when executed by the one or more processors cause the computing system to perform operations. The operations include obtaining data associated with a status of an autonomous vehicle. The operations include determining that the autonomous vehicle is to become available to perform one or more vehicle services at a later time based at least in part on the data associated with the status of the autonomous vehicle. The operations include indicating to a plurality of service entities that the autonomous vehicle is to become available to the plurality of service entities. The operations include obtaining data associated with one or more candidate vehicle service assignments. Each of the one or more candidate vehicle service assignments includes a request for the autonomous vehicle to perform the one or more vehicle services for an associated service entity.

Yet another example aspect of the present disclosure is directed to an autonomous vehicle. The autonomous vehicle includes one or more processors and one or more tangible, non-transitory, computer readable media that store instructions that when executed by the one or more processors cause the one or more processors to perform operations. The operations include determining that the autonomous vehicle is to become available to perform one or more vehicle services at a later time. The operations include indicating to one or more service entities that the autonomous vehicle is to become available to perform the one or more vehicle services. The operations include obtaining data associated with one or more candidate vehicle service assignments. Each of the one or more candidate vehicle service assignments is associated with a different service entity of the one or more service entities. The operations include determining a selected vehicle service assignment based at least in part on the data associated with the one or more candidate vehicle service assignments. The operations include causing the autonomous vehicle to initiate a motion control in accordance with the selected vehicle service assignment.

Other example aspects of the present disclosure are directed to systems, methods, vehicles, apparatuses, tangible, non-transitory computer-readable media, and memory devices for controlling autonomous vehicles and the selection of the vehicle services performed by the autonomous vehicles.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example vehicle computing system according to example embodiments of the present disclosure;

FIG. 2 depicts an example architecture according to example embodiments of the present disclosure;

FIG. 3 depicts an example vehicle fleet according to example embodiments of the present disclosure;

FIG. 4A and FIG. 4B. depict examples of vehicle service assignment queue according to example embodiments of the present disclosure;

FIG. 5 depicts an example geographic area according to example embodiments of the present disclosure;

FIG. 6 depicts a flow diagram of an example method for allocating an autonomous vehicle fleet according to example embodiments of the present disclosure;

FIG. 7 depicts a flow diagram of an example method for controlling autonomous vehicles according to example embodiments of the present disclosure;

FIG. 8 depicts a flow diagram of another example method for controlling autonomous vehicles according to example embodiments of the present disclosure;

FIG. 9 depicts a flow diagram of an example method for autonomous vehicle communication according to example embodiments of the present disclosure; and

FIG. 10 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improving the ability of an autonomous vehicle to select a service entity and/or a vehicle service assignment. An autonomous vehicle can be utilized to perform one or more vehicle services such as, for example, transportation services (e.g., rideshare services), courier services, delivery services, etc. The vehicle service(s) can be offered (e.g., via a mobile software application, website, etc.) to users by several different service entities (e.g., companies that offer and/or coordinate the provision of vehicle services to users). In the event that a user requests a vehicle service, a computing system of the associated service entity can send a vehicle service assignment to an autonomous vehicle. The vehicle service assignment can include a request for the vehicle to perform the vehicle service for the user and a variety of information about the requested vehicle service (e.g., location(s), time(s), vehicle service type, suggested route, etc.). The autonomous vehicle can be configured to receive a plurality of different vehicle service assignments from a plurality of different service entities.

The systems and methods of the present disclosure allow an autonomous vehicle to effectively choose a service entity from among the different services entities and/or a vehicle service assignment from among the different vehicle service assignments. For example, in some implementations, a third party (e.g., a vehicle owner, manager, etc.) can instruct the autonomous vehicle to perform vehicle services for a certain service entity (e.g., indefinitely, for a set time period, etc.). Additionally, or alternatively, the autonomous vehicle itself can determine (e.g., using onboard logic, etc.) which service entity to select based on a variety of information associated with the service entities (e.g., historic/current demand, compensation, incentives, agreed upon quotas, etc.). Moreover, to select among a plurality of vehicle service assignments, an autonomous vehicle can be configured to evaluate each of the plurality of vehicle service assignments in real-time (e.g., using an optimization function, etc.) and determine which of the vehicle service assignments to undertake. In this way, the systems and methods of the present disclosure provide an autonomous vehicle with the flexibility to perform vehicle services for a plurality of different service entities in a computationally efficient manner.

More particularly, an autonomous vehicle (e.g., ground-based vehicle, etc.) can include various systems and devices configured to control the operation of the vehicle. For example, an autonomous vehicle can include an onboard vehicle computing system (e.g., located on or within the autonomous vehicle) for operating the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the autonomous vehicle to communicate with one or more computing systems that are remote from the vehicle, as further described herein.

An autonomous vehicle can be associated with a third party. The third party can include, for example, an owner, a manufacturer, a vendor, a manager, a coordinator, a handler, etc. of the autonomous vehicle. The third party can be an individual, a group of individuals, an entity, a service entity, a group of entities, etc. In some implementations, the autonomous vehicle can be included in a fleet of autonomous vehicles associated with the third party. The third party can communicate (e.g., over one or more wireless communication channels) with the autonomous vehicle via a third party computing system that is remote from the autonomous vehicle. The third party computing system can include a server system (e.g., of an entity), a user device (e.g., of an individual owner), and/or other types of computing systems.

An autonomous vehicle can perform vehicle services for a plurality of different service entities. A service entity can be associated with the provision of one or more vehicle services. For example, a service entity can be an individual, a group of individuals, a company, a group of companies (e.g., affiliated entities), and/or another type of entity that offers and/or coordinates the performance of one or more vehicle services to one or more users. For example, a service entity can offer vehicle service(s) to users via one or more software applications (e.g., on a user computing device), via a website, and/or via other types of interfaces that allow a user to request a vehicle service. As described herein, the vehicle services can include transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services. The service entity can utilize an operations computing system to coordinate the provisions of vehicle service(s) associated with the service entity.

A user can provide (e.g., via a user device) a request for a vehicle service to an operations computing system associated with the service entity. The request can indicate the type of vehicle service that the user desires (e.g., a transportation service, a delivery service, a courier service, etc.), one or more locations (e.g., an origin, destination, etc.), timing constraints (e.g., pick-up time, drop-off time, deadlines, etc.), service parameters (e.g., a need for handicap access, a need for trunk space, etc.), and/or other information. The operations computing system of the service entity can process the request and identify one or more autonomous vehicles that may be able to perform the requested vehicle services for the user.

The operations computing system can send a vehicle service assignment indicative of the requested vehicle services to an autonomous vehicle via the service entity's computing platform. A computing platform of a service entity can provide the vehicle computing system (and/or the third party computing system) and the operations computing system with a computing environment that allows the systems to communicate. A computing platform can include a variety of computer architectures. Moreover, the computing platform can include the software, hardware, application programming interface(s), etc. that are associated with the service entity. Each service entity may have a different computing platform that can allow the service entity's operations computing system and the vehicle computing system (and/or the third party computing system) to communicate via a telecommunications network system of the service entity. One or more of the components of a computing platform can be accessible by the autonomous vehicle.

For instance, to help communicate with the various different service entities, a vehicle computing system of an autonomous vehicle can include a plurality of vehicle clients, each associated with a different service entity. A vehicle client can be firmware, software, etc. that is stored onboard a vehicle and that can allow the vehicle computing system to utilize a service entity's platform for communicating data to and/or obtaining data from the operations computing system associated with a service entity (e.g., a computing system that is remotely located from the vehicle). For example, a vehicle client can be implemented via hardware and/or software onboard the vehicle, such that the vehicle computing system can access an application programming interface associated with a service entity. The vehicle computing system can invoke, via the vehicle client, the application programming interface to access a library indicative of a plurality of parameters. The library can include, for example, a central repository for parameters that can be used to generate a communication (e.g., query string, message, data set, etc.) to be sent to the service entity's operations computing system. Moreover, the vehicle client can allow the vehicle computing system to receive data indicative of one or more vehicle service assignments from an associated service entity. The vehicle client can be communicated to an autonomous vehicle by an operations computing system associated with a service entity and/or communicated to a third party computing system that can then help implement the vehicle client on the autonomous vehicle.

To help select a service entity for which to perform a vehicle service, the vehicle computing system of an autonomous vehicle can obtain data associated with one or more service entities of a plurality of service entities. In some implementations, this data can be obtained from a third party computing system associated with the autonomous vehicle (e.g., a computing system of a vehicle vendor, vehicle owner, etc.), one or more operations computing systems associated with one or more service entities, and/or other computing system(s). The data associated with the one or more service entities can include a variety of information, as further described herein. The vehicle computing system can utilize this data to determine a selected service entity for which the autonomous vehicle is to perform the one or more vehicle services (e.g., for the use(s) that request a vehicle service associated with the service entity). This can include identifying a particular computing platform and/or network (e.g., for the vehicle to go online with, etc.) from among the plurality of platforms and/or networks associated with the different service entities.

The systems and methods of the present disclosure provide a variety of approaches by which an autonomous vehicle can select a service entity. In some implementations, a third party can instruct the autonomous vehicle to select a certain service entity. For instance, as described herein, the autonomous vehicle can be included in a fleet of autonomous vehicles associated with a third party. The third party may decide to designate at least a portion of its fleet to a selected service entity (e.g., based on a service level agreement with the service entity, etc.). The autonomous vehicle can be included within the portion of the fleet that is designated for the selected service entity. As such, the data associated with the one or more service entities obtained by the vehicle computing system can include data identifying a selected service entity that is designated by the third party. Such data can include, for example, an instruction for the vehicle computing system to only accept vehicle service assignments from the selected service entity, an instruction for the vehicle computing system to go online with the selected service entity (e.g., launch the associated vehicle client, open a communications session with an associated operations computing system, indicate vehicle availability to the associated operations computing system, etc.), and/or other types of data. In some implementations, the data identifying the selected service entity can include a configuration change that allows the autonomous vehicle to communicate with (e.g., receive vehicle service assignments from, etc.) the operations computing system of the selected service entity. For example, the third party computing system can push a service query over a wireless network to the vehicle computing system instructing the autonomous vehicle as to what vehicle clients, computing platforms, networks, and/or operations computing systems the vehicle is supposed to use for the selected service entity. The instructions and/or configuration changes can be exclusive such that the vehicle computing system can only go online with, receive/accept vehicle service assignments from, etc. that selected service entity. In some implementations, the third party can identify more than one selected service entity for which the autonomous vehicle is to perform a vehicle service.

In some implementations, the autonomous vehicle itself can select a service entity from among the plurality of different service entities. For instance, as described herein, the vehicle computing system can obtain data associated with one or more service entities. This can include various types of information associated with the vehicle service(s) of one or more of the different service entities. By way of example, the vehicle computing system can obtain historic vehicle service data that is indicative of historic service trend(s) associated with a respective service entity (e.g., historic levels of demand for vehicle service(s), historic volume(s) of user requests, historic volume(s) of vehicle service assignments, historic volumes of vehicle supply for the service entity, previous events in a geographic area, etc.). Additionally, or alternatively, the vehicle computing system can obtain current vehicle service data that is indicative of a current: level of demand for vehicle service(s), volume of user requests, volume of vehicle service assignments, volume of vehicle supply available to perform vehicle services for the service entity, events (e.g., sporting events, concerts, etc.), and/or other information. Additionally, or alternatively, the vehicle computing system can obtain future vehicle service data that is indicative of a known and/or a predicted future: level of demand for vehicle service(s), volume of user requests, current volume of vehicle service assignments, current volume of vehicle supply available to perform vehicle service(s) for the service entity, events, and/or other information. In some implementations, the information can be associated with a particular time period (e.g., certain day, month, time of day, during weekdays, during weekends, etc.) and/or geographic area.

Additionally, or alternatively, the vehicle computing system can obtain vehicle service compensation data. Such data can be indicative of the historic, current, and/or future level of compensation provided by a respective service entity for its vehicle service(s). In some implementations, the compensation data can be associated with a particular time period and/or geographic area.

Additionally, or alternatively, the vehicle computing system can obtain data indicative of one or more vehicle service quotas. Such data can indicate, for example, a quota of vehicle service assignments that the autonomous vehicle is supposed to address for the service entity (e.g., in a given time period), the amount of time an autonomous vehicle is supposed to be available to the service entity, the progress the autonomous vehicle has made toward meeting such a quota (e.g., how many vehicle service assignments have been made, how many are left to fill the quota, etc.), and/or other information. In some implementations, the quota can be associated with an individual autonomous vehicle (e.g., how many transportation trips that vehicle is supposed to complete within a given month). Additionally, or alternatively, the quota can be an aggregate quota associated with a vehicle fleet or a portion thereof (e.g., how many aggregate transportation trips the fleet or a portion thereof is to complete in a given week). In some implementations, a quota can be associated with a particular time period and/or geographic area.

In some implementations, the vehicle computing system can obtain data indicative of one or more vehicle service incentives. For example, a service entity may provide an autonomous vehicle an incentive to go online with the service entity (e.g., to become available to receive vehicle service assignments and/or perform vehicle services for, etc.). Such an incentive can include increased compensation, a priority on preferred vehicle service assignments (e.g., from highly rated users, etc.), an increase in vehicle rating, and/or other incentives. In some implementations, the incentive(s) can be associated with a particular time period and/or geographic area.

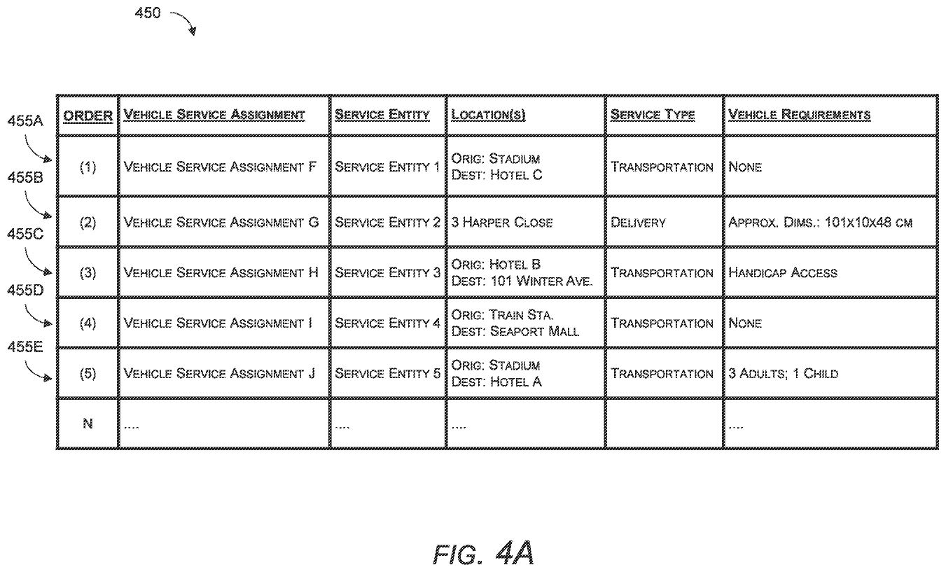

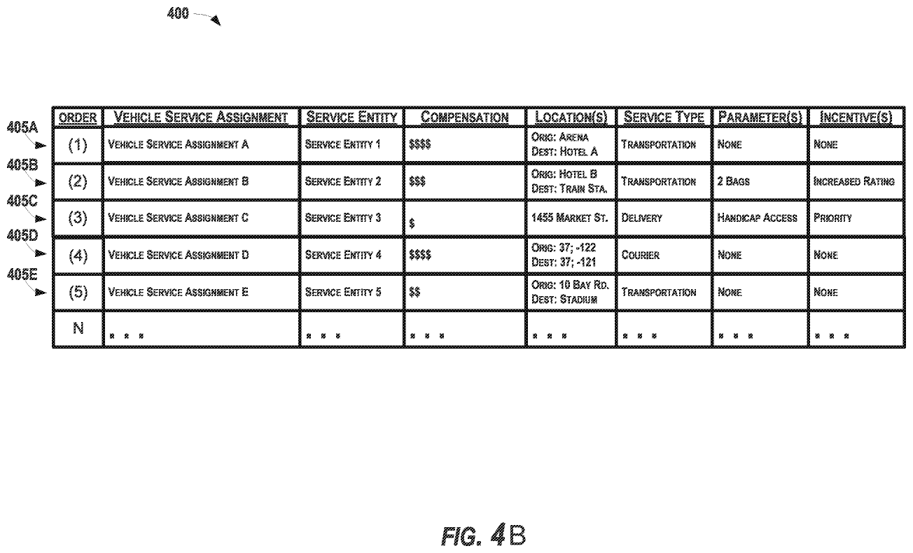

The vehicle computing system can determine the selected service entity based at least in part on one or more of these types of data. For instance, the vehicle computing system can include programmed logic, heuristics, models (e.g., machine-learned models), etc. that can be utilized to evaluate the data associated with the one or more service entities and select a service entity for the autonomous vehicle (e.g., select a service entity platform and/or network for the autonomous vehicle). By way of example, the vehicle computing system can apply an optimization function that can weigh the different types of data and provide the vehicle computing system with a recommended service entity. One or more types of data can be given the same weight and/or one or more types of data can be given different weights. For example, in one embodiment, the optimization function can apply a greater weight to parameters related to physical requirements of the vehicle when the vehicle is detected to be able to meet those requirements. The use of such physical parameters to weigh the recommended service entity is described in detail below, for example with reference to FIG. 4A. In a different embodiment, the optimization function can apply a greater weight to any agreed-upon quotas and/or current levels of compensation and apply lower weights to historic vehicle service data.

In some implementations, the vehicle computing system may consider whether there is a preferred service entity for the autonomous vehicle. For example, a third party computing system can communicate data identifying a particular service entity as a preferred service entity. The vehicle computing system can obtain such data and weigh it during its service entity selection process.

In some implementations, the autonomous vehicle can select a service entity for a particular time period. For instance, a third party computing system can communicate data, to the vehicle computing system, identifying a first selected service entity for the autonomous vehicle and a first time period during which the autonomous vehicle is to be available to receive vehicle service assignments and/or perform vehicle services for the first service entity (e.g., perform the vehicle services requested by the users associated with the service entity). The vehicle computing system can obtain this data and determine that the autonomous vehicle is to perform vehicle service(s) for the first selected service entity during the first time period. For example, the vehicle computing system can go online with only the first service entity (e.g., its computing platform, network, etc.) such that the autonomous vehicle solely performs vehicle service(s) for the first service entity during the first time period. The vehicle computing system can also obtain data (e.g., from a third party computing system, etc.) identifying a second selected service entity and a second time period. As such, the vehicle computing system can determine that the autonomous vehicle should perform vehicle service(s) for the second selected service entity during the second time period (e.g., solely perform the vehicle service(s) for the users that make requests to the second service entity). By way of example, based on the data obtained from the third party computing system, the vehicle computing system can determine that the autonomous vehicle is to perform transportation service(s) for the first selected service entity during weekdays and is to perform transportation services for the second selected service entity during weekends.

Additionally or alternatively, the vehicle computing system can determine that the autonomous vehicle should perform vehicle service(s) for the first selected service entity during the first time period using, for example, its onboard programmed logic, heuristics, models, etc., as described herein. By way of example, the vehicle computing system can determine that it would be advantageous for the autonomous vehicle to perform delivery service(s) for a first selected service entity during the daytime. In some implementations, the vehicle computing system can determine another selected service entity for which the autonomous vehicle is to perform vehicle service(s) during a second time period (e.g., using its optimization function). For example, the vehicle computing system can determine that the autonomous vehicle should perform transportation services for a second selected entity during the nighttime.

Once the vehicle computing system determines the one or more selected vehicle service entities, the vehicle computing system can indicate that the autonomous vehicle is available to perform the vehicle service(s) associated with the one or more selected service entities. The vehicle computing system can indicate such availability by communicating directly with the operations computing system of the service entity (e.g., to send data indicative of the vehicle's availability, changing a vehicle status indicator, etc.), indirectly communicating the vehicle's availability to the operations computing system of the service entity (e.g., by communicating data indicative of the vehicle's availability to the third party computing system that can communicate with the operations computing system of the service entity, changing a vehicle status indicator, etc.), going online with the service entity, and/or other types of indications.

For instance, the vehicle computing system can cause the autonomous vehicle to go online with a particular service entity (and/or its associated computing platform) such that the vehicle is able to receive data indicative of one or more vehicle service assignments associated with that service entity. By way of example, the vehicle computing system can include a first vehicle client associated with a first selected service entity. The vehicle computing system can indicate the vehicle's availability by launching the software of the first vehicle client. The vehicle computing system can establish a first communication session with a first remote computing system associated with the first selected service entity (e.g., the operations computing system of the first selected service entity). The communication session can be opened based at least in part on an application programming interface associated with the first service entity. For instance, the vehicle computing system can access, via the first vehicle client, a first application programming interface associated with the first selected service entity. The vehicle computing system can generate a first communication (e.g., data string, etc.) based at least in part on the first application programming interface (e.g., based on the defined parameters thereof, etc.). The first communication can indicate that the autonomous vehicle is available to perform vehicle service(s) for the first selected service entity. The vehicle computing system can communicate the first communication to the operations computing system of the first service entity to indicate that the autonomous vehicle is online with the entity's computing platform/network and that the autonomous vehicle is available to perform vehicle service(s) for the first service entity.

In the event that the autonomous vehicle determines that it is to perform vehicle service(s) for another, second service entity (that is different from the first service entity), the vehicle computing system can open a second communication session with the second service entity in a manner similar to that described above. In some implementations, the second communication session can be established concurrently with the first communication session. In the event that the vehicle computing system determines that it is to solely perform vehicle service(s) to a certain service entity (e.g., during a time period set by a third party, during a time period determined by the vehicle itself, etc.), the vehicle computing system can terminate the first communication session or second communication session. In some implementations, the vehicle computing system can wait until after the first time period and/or after a first communication session is closed to indicate that the autonomous vehicle is available to perform vehicle service(s) for another service entity.

In some implementations, the third party computing system can establish one or more communication session with one or more operations computing systems. An autonomous vehicle can communicate data to and/or obtain data from the service entity via the third party computing system. In this way, the autonomous vehicle can be available to preform vehicle services for one or more service entities (e.g., at concurrent time frames) via the third party computing system.

The vehicle computing system can obtain data indicative of one or more vehicle service assignments associated with the one or more selected service entities (e.g., via the communication session(s)). For instance, an operations computing system of a selected service entity can communicate data indicative of a candidate vehicle service assignment to the vehicle computing system of the autonomous vehicle. In some implementations, the candidate vehicle service assignment can be a vehicle service request that the vehicle computing system may consider for acceptance. In some implementations, the candidate vehicle service assignment can be a command that the autonomous vehicle is required to accept. The vehicle computing system can select the candidate vehicle service assignment and communicate data indicative of its acceptance to the operation computing system of the selected service entity. Moreover, the vehicle computing system can cause the autonomous vehicle to initiate a motion control in accordance with the selected vehicle service assignment. By way of example, the vehicle service assignment can indicate that the autonomous vehicle is to transport a user from an origin location to a destination location within a certain timeframe. The vehicle service assignment can indicate a compensation parameter, any incentives associated with the transportation service assignment, and/or other information. The vehicle computing system can cause the autonomous vehicle to initiate a motion control (e.g., via an onboard autonomy system and the vehicle's control systems, etc.) in accordance with the accepted vehicle service assignment by, for example, causing the vehicle to autonomously travel to the origin location of the user to be transported.

In addition, or alternatively, example aspects of the present disclosure can provide an autonomous vehicle with the ability to select a vehicle service assignment from among a plurality of candidate vehicle service assignments. For instance, the vehicle computing system can indicate to a plurality of service entities that the autonomous vehicle is available to perform one or more vehicle services for the service entities. As described herein, this can include the vehicle computing system going online with the respective computing platform/network of each of the service entities, establishing a communication session with the operations computing systems of each service entity, etc. The vehicle computing system can obtain data associated with a plurality of candidate vehicle service assignments (e.g., via the networks, communication sessions, etc.). Each of the candidate vehicle service assignments can be associated with a different service entity. In some implementations, a plurality of candidate vehicle assignments may be provided by a single service entity.

The vehicle computing system can be configured to analyze the plurality of candidate vehicle service assignments to select at least one for the autonomous vehicle. For instance, the vehicle computing system can store at least a portion of the data associated with the plurality of candidate vehicle service assignments in a vehicle service assignment queue (e.g., located in the onboard memory of the autonomous vehicle, an offboard memory, etc.). For example, the data associated with the plurality of vehicle service assignments can include data indicative of a compensation parameter for each respective candidate vehicle service assignment (e.g., the compensation for delivering an item to a user, etc.), data indicative of one or more locations associated with each respective candidate vehicle service assignment (e.g., origin location, destination location, intermediate location, etc.), data indicative of a type of vehicle service associated with each respective vehicle assignment (e.g., transportation service, delivery service, courier service, etc.), data indicative of one or more time constraints associated with each respective vehicle assignment (e.g., pick-up times, drop-off times, time limits for delivery, service duration, etc.), data indicative of an order in which each vehicle service assignment was obtained by the autonomous vehicle, data indicative of one or more vehicle service parameters associated with one or more of the vehicle service assignments (e.g., luggage, handle-with-care instructions, special pick-up requests, etc.), data indicative of one or more vehicle service incentives associated with one or more of the vehicle service assignments, and/or other types of data. In some implementations, the vehicle computing system can obtain data indicative of a preferred service entity (e.g., as identified by a third party) to consider when evaluating the candidate vehicle service assignments.

The vehicle computing system can select a vehicle service assignment based at least in part on these types of data. For instance, the vehicle computing system can apply an optimization function that weighs the various types of data, as similarly described herein. In some implementations, the weights of each type of data can change based on attributes of the vehicle. In other implementations, the weights of each type of data can change based on the time of day, the status of the vehicle, and/or other factors. In one embodiment, the weights can be applied based on dynamic sensor data obtained from the vehicle. For example, the vehicle can be equipped with cameras to detect in real-time the current capacity of the vehicle so that a greater weight can be applied to data which would keep the capacity below the maximum carrying load. In a different embodiment, and by way of example, the autonomous vehicle may be owned by a third party individual that makes the autonomous vehicle available to the plurality of service entities while the individual is at work. The optimization function may apply a higher weight to the compensation parameter during the daytime. The optimization function may apply a higher weight to the location(s) (e.g., destination location, etc.) and/or time constraint(s) (e.g., vehicle service duration, etc.) during the end of the day when the third party individual may need the autonomous vehicle to pick-up the individual from the individual's workplace at a certain time. In this way, the vehicle computing system can determine a selected vehicle service assignment from among the plurality of candidate vehicle service assignments associated with the different service entities.

The vehicle computing system can indicate to the service entity associated with the selected vehicle service assignment that the autonomous vehicle will address (e.g., provide, perform, undertake, etc.) the selected vehicle service assignment. For instance, the vehicle computing system can communicate (e.g., send, transfer, transmit, make available to, etc.) data indicative of an acceptance of the selected vehicle service assignment to a remote computing system associated with the service entity that is associated with the selected vehicle service assignment. The data indicative of the acceptance can be, for example, a communication formulated based at least in part on an application programming interface associated with the service entity (e.g., a data message structured using API parameters to indicate the acceptance, etc.). By way of example, the vehicle computing system can communicate (e.g., to the operations computing system of the service entity) a message indicating that the autonomous vehicle will perform the requested transportation service for a user indicated in the candidate vehicle service assignment.

In some implementations, the vehicle computing system can indicate to the other service entities that it did not select the vehicle service assignments associated with those service entities. For instance, the vehicle computing system can communicate data indicative of one or more rejections of the one or more candidate vehicle service assignments that are not the selected vehicle service assignment to the operations computing systems of the associated service entities. Moreover, the vehicle computing system can also indicate to these service entities that the autonomous vehicle is unavailable to those service entities while the vehicle is addressing the selected vehicle service assignment. This can include, for example, the vehicle computing system going offline with respect to those service entities (e.g., terminating a communication session with the operations communications systems of those service entities, closing a vehicle client, otherwise disconnecting from the computing platform/network, etc.), adjusting a status indicator associated with the autonomous vehicle (e.g., to an unavailable status while maintaining the communication session), communicating to those service entities to indicate that the autonomous vehicle is unavailable, and/or other approaches.

The autonomous vehicle can travel to address the selected vehicle service assignment. For instance, as described herein, the vehicle computing system can cause the autonomous vehicle to initiate a motion control in accordance with the selected vehicle service assignment. By way of example, the vehicle computing system (e.g., an autonomy system) can send one or more signals to the vehicle control systems of the autonomous vehicle such that the autonomous vehicle autonomously travels to an origin location to pick-up a user and to a destination to drop-off the user for a transportation service request. Following completion of the selected vehicle service assignment, the vehicle computing system can indicate to each service entity of the plurality of service entities that the autonomous vehicle is available again to perform vehicle service(s) for the service entities, as described herein.

In some implementations, the autonomous vehicle can be configured to pre-broadcast its availability to the service entities. For instance, the autonomous vehicle can be addressing a current task associated with the autonomous vehicle and/or otherwise be in a state where the autonomous vehicle is unavailable to one or more of the service entities. In some implementations, the current task can include addressing a selected vehicle service assignment (e.g., transporting a user). In some implementations, the current task can include receiving maintenance, receiving fuel, charging an electric power source of the autonomous vehicle, etc. The vehicle computing system can obtain data associated with the status of the autonomous vehicle. This can include the status of the current task of the autonomous vehicle. By way of example, the vehicle computing system can obtain data indicating how long until the autonomous vehicle will complete a current vehicle service assignment (e.g., how long until the vehicle drops-off a user at a destination location).

The vehicle computing system can determine that the autonomous vehicle is to become available to perform one or more vehicle services (at a later time) based at least in part on the data associated with the status of the autonomous vehicle. For instance, the vehicle computing system can determine that the autonomous vehicle is to become available based at least in part on the status of the vehicle's current task. By way of example, the vehicle computing system can determine that the autonomous vehicle will soon arrive at a destination location for a current transportation service assignment. In another example, the vehicle computing system can determine that the vehicle maintenance, re-fueling, re-charging, etc. will be completed shortly.

The vehicle computing system can indicate to a plurality of service entities that the autonomous vehicle is to become available (at the later time) to perform one or more vehicle services. Such indication can take place before the autonomous vehicle has completed its current task. For instance, the vehicle computing system can go online with (e.g.,, establish a plurality of communication sessions with, provide communications to, etc.) the plurality of service entities to indicate the vehicle's upcoming availability. By way of example, the autonomous vehicle can be addressing a first vehicle service assignment (e.g., a first transportation service assignment) for a first service entity. Prior to completion of the first vehicle service assignment, the vehicle computing system can indicate to a plurality of other vehicle service entities that the autonomous vehicle is to become available for another vehicle service assignment. In some implementations, the vehicle computing system can provide a time (e.g., estimated time, estimated amount of time, etc.) when the autonomous vehicle will become available and/or able to accept a vehicle service assignment. The vehicle computing system can obtain data associated with a plurality of candidate service assignments from a plurality of different service entities, prior to completion of the vehicle's current task. Moreover, before the vehicle completes the current task, the vehicle computing system can select a vehicle service assignment for the autonomous vehicle to address. Such selection can be made, for example, using the processes described herein.

In some implementations, the vehicle computing system can determine the selected vehicle assignment based at least in part on the current task of the autonomous vehicle. For example, the selected vehicle service assignment can be a second transportation service assignment that has a pick-up location in the vicinity of the drop-off location of a first transportation service assignment currently being addressed by the autonomous vehicle. The second vehicle service assignment can be associated with a second service entity that is different than the first service entity. The vehicle computing system can accept the second vehicle service assignment before the vehicle completes the first transportation service assignment. In this way, by pre-broadcasting its availability, the autonomous vehicle can pre-emptively obtain vehicle service assignments across different service entities (and their associated computing platforms).

The systems and methods described herein provide a number of technical effects and benefits. For instance, the systems and methods allow an autonomous vehicle to interface with multiple different service entities. The autonomous vehicle can determine which of the service entities and/or vehicle service assignments would be most appropriate and efficient for the autonomous vehicle. As such, the autonomous vehicle is able to customize its performance of vehicle services. This can lead to a more effective use of fuel, data, power, processing, memory, and/or other resources as the autonomous vehicle accepts vehicle service assignments from a plurality of different service entities. For example, the systems and methods of the present disclosure allow an autonomous vehicle to obtain vehicle service assignments across a multitude of different computing platforms, which in turn provides the autonomous vehicle with a greater ability to select vehicle service assignments that are geographically proximate. This can allow the autonomous vehicle to save processing and memory resources as the autonomous vehicle navigates a more well-known geographic area. In another example, the systems and methods provide an autonomous vehicle with the flexibility to select vehicle service assignments that involve more desirable time constraints. This can allow the autonomous vehicle to more easily attend to its maintenance, re-fueling, re-charging, and/or other needs, with less vehicle downtime.

The systems and methods described herein also allow an autonomous vehicle to more readily obtain a variety of different types of vehicle service assignments. For example, an autonomous vehicle can interface with a service entity that offers only transportation services and another service entity that only offers delivery services. The technology of the present disclosure provides the autonomous vehicle with an efficient approach for obtaining transportations service assignments from one entity and delivery service assignments from another and determining which of these vehicle service assignments are in the best interest of the autonomous vehicle. In this way, the autonomous vehicle is afforded greater flexibility to obtain and select from the various types of vehicle service assignments from different service entities.

Additionally, the technology described herein is scalable across various types of vehicle ownership structures. For example, the systems and methods of the present disclosure allow an owner, manager, etc. of a fleet of autonomous vehicles to efficiently allocate autonomous vehicles across multiple service entities (e.g., and the related vehicle service platforms). Moreover, as described herein, the technology of the present disclosure allows an autonomous vehicle to autonomously select service entities and/or vehicle service assignments. This can increase an individual owner's confidence in the autonomous vehicle while also alleviating the decision-making burden on the individual owner (e.g., to constantly select vehicle service assignments for the vehicle). Ultimately, an autonomous vehicle's ability to select a service entity and/or vehicle service assignment (without constant user input) can increase vehicle efficiency as well as the frequency with which the autonomous vehicle accepts and addresses vehicle service assignments.

The systems and methods of the present disclosure can provide an improvement to vehicle computing technology, such as autonomous vehicle computing technology. For instance, the systems and methods provide an improved approach to selecting among a plurality of different service entities and/or vehicle service assignments. For example, a computing system (e.g., a vehicle computing system) can obtain data associated with a plurality of service entities. As described herein, the computing system can determine a first service entity for which the autonomous vehicle is to perform the one or more vehicle services. The computing system can indicate (e.g., to a remote computing system associated with the first service entity) that the autonomous vehicle is available to the first service entity. The computing system can obtain data indicative of a vehicle service assignment associated with the first service entity and cause the autonomous vehicle to initiate a motion control in accordance with the vehicle service assignment. In this way, the autonomous vehicle can efficiently select a service entity from among a plurality of service entities, saving time and onboard computational resources.

The systems and methods of the present disclosure also provide an improved approach to the selection of vehicle service assignments from a plurality of different vehicle service assignments. For example, a computing system (e.g., a vehicle computing system) can obtain data associated with a plurality of candidate vehicle service assignments, each associated with a different service entity. The computing system can determine a selected vehicle service assignment based at least in part on the data associated with the plurality of candidate vehicle service assignments (e.g., without input from a vehicle operator, etc.). The computing system can send data indicative of an acceptance of the selected vehicle service assignment to a remote computing system associated with the service entity of the selected vehicle service assignment. The computing system can cause the autonomous vehicle to initiate a motion control in accordance with the selected vehicle service assignment. Accordingly, the computing system can autonomously select a vehicle service assignment from a plurality of different service entities without relying on user input. This can increase the efficiency with which an autonomous vehicle accepts vehicle service assignments, leading to less vehicle downtime and wasted resources (e.g., processing, memory, fuel, power, etc. as the vehicle waits for a user's decision).

The systems and methods of the present disclosure also improve the ability of an autonomous vehicle computing system to communicate its availability to different service entities across different computing platforms. For instance, a computing system (e.g., a vehicle computing system) can obtain data associated with a status of the autonomous vehicle. This can include, for example, the status of a current task being performed by the autonomous vehicle (e.g., a vehicle service assignment, maintenance, re-fueling, re-charging, etc.). The computing system can determine that the autonomous vehicle is to become available, at a later time, to perform one or more vehicle services based at least in part on the data associated with the status of the autonomous vehicle. For example, the computing system can determine that the autonomous vehicle will soon complete a current vehicle service assignment (e.g., soon arrive at a drop-off location for an item to be delivered). The computing system can indicate to a plurality of service entities that the autonomous vehicle is to become available to perform the one or more vehicle services (e.g., before completion of the current task). Moreover, the computing system can receive, select, and accept a vehicle service assignment before completion of the current task. In this way, the vehicle computing system can pro-actively and pre-emptively select vehicle service assignments, leading to a more efficient use of the vehicle's time and resources as well as less vehicle downtime.

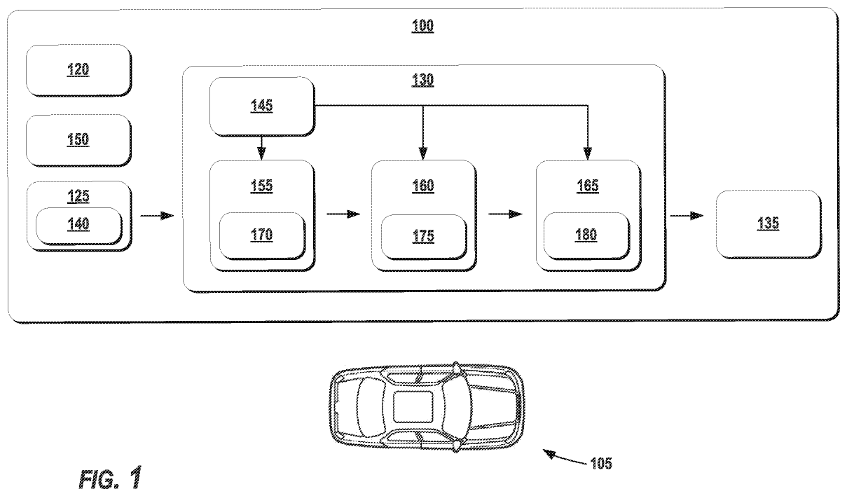

With reference now to the FIGS., example embodiments of the present disclosure will be discussed in further detail. FIG. 1 illustrates an example vehicle computing system 100 according to example embodiments of the present disclosure. The vehicle computing system 100 can be associated with a vehicle 105. The vehicle computing system 100 can be located onboard (e.g., included on and/or within) the vehicle 105.

The vehicle 105 incorporating the vehicle computing system 100 can be various types of vehicles. For instance, the vehicle 105 can be a ground-based autonomous vehicle such as an autonomous car, autonomous truck, autonomous bus, etc. The vehicle 105 can be an air-based autonomous vehicle (e.g., airplane, helicopter, or other aircraft) or other types of vehicles (e.g., watercraft, etc.). The vehicle 105 can be an autonomous vehicle that can drive, navigate, operate, etc. with minimal and/or no interaction from a human operator (e.g., driver). In some implementations, a human operator can be omitted from the vehicle 105 (and/or also omitted from remote control of the vehicle 105). In some implementations, a human operator can be included in the vehicle 105.

In some implementations, the vehicle 105 can be configured to operate in a plurality of operating modes. The vehicle 105 can be configured to operate in a fully autonomous (e.g., self-driving) operating mode in which the vehicle 105 is controllable without user input (e.g., can drive and navigate with no input from a human operator present in the vehicle 105 and/or remote from the vehicle 105). The vehicle 105 can operate in a semi-autonomous operating mode in which the vehicle 105 can operate with some input from a human operator present in the vehicle 105 (and/or a human operator that is remote from the vehicle 105). The vehicle 105 can enter into a manual operating mode in which the vehicle 105 is fully controllable by a human operator (e.g., human driver, pilot, etc.) and can be prohibited and/or disabled (e.g., temporary, permanently, etc.) from performing autonomous navigation (e.g., autonomous driving). In some implementations, the vehicle 105 can implement vehicle operating assistance technology (e.g., collision mitigation system, power assist steering, etc.) while in the manual operating mode to help assist the human operator of the vehicle 105.

The operating modes of the vehicle 105 can be stored in a memory onboard the vehicle 105. For example, the operating modes can be defined by an operating mode data structure (e.g., rule, list, table, etc.) that indicates one or more operating parameters for the vehicle 105, while in the particular operating mode. For example, an operating mode data structure can indicate that the vehicle 105 is to autonomously plan its motion when in the fully autonomous operating mode. The vehicle computing system 100 can access the memory when implementing an operating mode.

The operating mode of the vehicle 105 can be adjusted in a variety of manners. For example, the operating mode of the vehicle 105 can be selected remotely, off-board the vehicle 105. For example, a remote computing system (e.g., of a third party and/or service entity associated with the vehicle 105) can communicate data to the vehicle 105 instructing the vehicle 105 to enter into, exit from, maintain, etc. an operating mode. By way of example, such data can instruct the vehicle 105 to enter into the fully autonomous operating mode. In some implementations, the operating mode of the vehicle 105 can be set onboard and/or near the vehicle 105. For example, the vehicle computing system 100 can automatically determine when and where the vehicle 105 is to enter, change, maintain, etc. a particular operating mode (e.g., without user input). Additionally, or alternatively, the operating mode of the vehicle 105 can be manually selected via one or more interfaces located onboard the vehicle 105 (e.g., key switch, button, etc.) and/or associated with a computing device proximate to the vehicle 105 (e.g., a tablet operated by authorized personnel located near the vehicle 105). In some implementations, the operating mode of the vehicle 105 can be adjusted by manipulating a series of interfaces in a particular order to cause the vehicle 105 to enter into a particular operating mode.

The vehicle computing system 100 can include one or more computing devices located onboard the vehicle 105. For example, the computing device(s) can be located on and/or within the vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 105 (e.g., its computing system, one or more processors, etc.) to perform operations and functions, such as those described herein for controlling an autonomous vehicle, selecting a service entity and/or vehicle service assignment, communicating vehicle availability, etc.

The vehicle 105 can include a communications system 120 configured to allow the vehicle computing system 100 (and its computing device(s)) to communicate with other computing devices. The vehicle computing system 100 can use the communications system 120 to communicate with one or more computing device(s) that are remote from the vehicle 105 over one or more networks (e.g., via one or more wireless signal connections). In some implementations, the communications system 120 can allow communication among one or more of the system(s) on-board the vehicle 105. The communications system 120 can include any suitable components for interfacing with one or more network(s), including, for example, transmitters, receivers, ports, controllers, antennas, and/or other suitable components that can help facilitate communication.

As shown in FIG. 1, the vehicle 105 can include one or more vehicle sensors 125, an autonomy computing system 130, one or more vehicle control systems 135, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 125 can be configured to acquire sensor data 140. This can include sensor data associated with the surrounding environment of the vehicle 105. For instance, the sensor data 140 can acquire image and/or other data within a field of view of one or more of the vehicle sensor(s) 125. The vehicle sensor(s) 125 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 140 can include image data, radar data, LIDAR data, and/or other data acquired by the vehicle sensor(s) 125. The vehicle 105 can also include other sensors configured to acquire data associated with the vehicle 105. For example, the vehicle 105 can include inertial measurement unit(s), wheel odometry devices, and/or other sensors.

In some implementations, the sensor data 140 can be indicative of one or more objects within the surrounding environment of the vehicle 105. The object(s) can include, for example, vehicles, pedestrians, bicycles, and/or other objects. The object(s) can be located in front of, to the rear of, to the side of the vehicle 105, etc. The sensor data 140 can be indicative of locations associated with the object(s) within the surrounding environment of the vehicle 105 at one or more times. The vehicle sensor(s) 125 can provide the sensor data 140 to the autonomy computing system 130.

In addition to the sensor data 140, the autonomy computing system 130 can retrieve or otherwise obtain map data 145. The map data 145 can provide information about the surrounding environment of the vehicle 105. In some implementations, a vehicle 105 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the vehicle 105 in comprehending and perceiving its surrounding environment and its relationship thereto. In some implementations, the vehicle computing system 100 can determine a vehicle route for the vehicle 105 based at least in part on the map data 145.

The vehicle 105 can include a positioning system 150. The positioning system 150 can determine a current position of the vehicle 105. The positioning system 150 can be any device or circuitry for analyzing the position of the vehicle 105. For example, the positioning system 150 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the vehicle 105 can be used by various systems of the vehicle computing system 100 and/or provided to a remote computing system. For example, the map data 145 can provide the vehicle 105 relative positions of the elements of a surrounding environment of the vehicle 105. The vehicle 105 can identify its position within the surrounding environment (e.g., across six axes, etc.) based at least in part on the map data. For example, the vehicle computing system 100 can process the sensor data 140 (e.g., LIDAR data, camera data, etc.) to match it to a map of the surrounding environment to get an understanding of the vehicle's position within that environment.

The autonomy computing system 130 can include a perception system 155, a prediction system 160, a motion planning system 165, and/or other systems that cooperate to perceive the surrounding environment of the vehicle 105 and determine a motion plan for controlling the motion of the vehicle 105 accordingly. For example, the autonomy computing system 130 can obtain the sensor data 140 from the vehicle sensor(s) 125, process the sensor data 140 (and/or other data) to perceive its surrounding environment, predict the motion of objects within the surrounding environment, and generate an appropriate motion plan through such surrounding environment. The autonomy computing system 130 can communicate with the one or more vehicle control systems 135 to operate the vehicle 105 according to the motion plan.

The vehicle computing system 100 (e.g., the autonomy computing system 130) can identify one or more objects that are proximate to the vehicle 105 based at least in part on the sensor data 140 and/or the map data 145. For example, the vehicle computing system 100 (e.g., the perception system 155) can process the sensor data 140, the map data 145, etc. to obtain perception data 170. The vehicle computing system 100 can generate perception data 170 that is indicative of one or more states (e.g., current and/or past state(s)) of a plurality of objects that are within a surrounding environment of the vehicle 105. For example, the perception data 170 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 155 can provide the perception data 170 to the prediction system 160 (and/or the motion planning system 165).

The prediction system 160 can be configured to predict a motion of the object(s) within the surrounding environment of the vehicle 105. For instance, the prediction system 160 can generate prediction data 175 associated with such object(s). The prediction data 175 can be indicative of one or more predicted future locations of each respective object. For example, the prediction system 160 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175 can be indicative of the speed and/or acceleration at which the respective object is predicted to travel along its associated predicted motion trajectory. The prediction system 160 can output the prediction data 175 (e.g., indicative of one or more of the predicted motion trajectories) to the motion planning system 165.

The vehicle computing system 100 (e.g., the motion planning system 165) can determine a motion plan 180 for the vehicle 105 based at least in part on the perception data 170, the prediction data 175, and/or other data. A motion plan 180 can include vehicle actions (e.g., planned vehicle trajectories, speed(s), acceleration(s), other actions, etc.) with respect to one or more of the objects within the surrounding environment of the vehicle 105 as well as the objects' predicted movements. For instance, the motion planning system 165 can implement an optimization algorithm, model, etc. that considers cost data associated with a vehicle action as well as other objective functions (e.g., cost functions based on speed limits, traffic lights, etc.), if any, to determine optimized variables that make up the motion plan 180. The motion planning system 165 can determine that the vehicle 105 can perform a certain action (e.g., pass an object, etc.) without increasing the potential risk to the vehicle 105 and/or violating any traffic laws (e.g., speed limits, lane boundaries, signage, etc.). For instance, the motion planning system 165 can evaluate one or more of the predicted motion trajectories of one or more objects during its cost data analysis as it determines an optimized vehicle trajectory through the surrounding environment. The motion planning system 165 can generate cost data associated with such trajectories. In some implementations, one or more of the predicted motion trajectories may not ultimately change the motion of the vehicle 105 (e.g., due to an overriding factor). In some implementations, the motion plan 180 may define the vehicle's motion such that the vehicle 105 avoids the object(s), reduces speed to give more leeway to one or more of the object(s), proceeds cautiously, performs a stopping action, etc.

The motion planning system 165 can be configured to continuously update the vehicle's motion plan 180 and a corresponding planned vehicle motion trajectory. For example, in some implementations, the motion planning system 165 can generate new motion plan(s) 180 for the vehicle 105 (e.g., multiple times per second). Each new motion plan can describe a motion of the vehicle 105 over the next planning period (e.g., next several seconds). Moreover, a new motion plan may include a new planned vehicle motion trajectory. Thus, in some implementations, the motion planning system 165 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the vehicle 105.

The vehicle computing system 100 can cause the vehicle 105 to initiate a motion control in accordance with at least a portion of the motion plan 180. A motion control can be an operation, action, etc. that is associated with controlling the motion of the vehicle. For instance, the motion plan 180 can be provided to the vehicle control system(s) 135 of the vehicle 105. The vehicle control system(s) 135 can be associated with a vehicle controller (e.g., including a vehicle interface) that is configured to implement the motion plan 180. The vehicle controller can, for example, translate the motion plan into instructions for the appropriate vehicle control component (e.g., acceleration control, brake control, steering control, etc.). By way of example, the vehicle controller can translate a determined motion plan 180 into instructions to adjust the steering of the vehicle 105 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 180 (e.g., by sending control signal(s), making the translated plan available, etc.). This can allow the vehicle 105 to autonomously travel within the vehicle's surrounding environment.

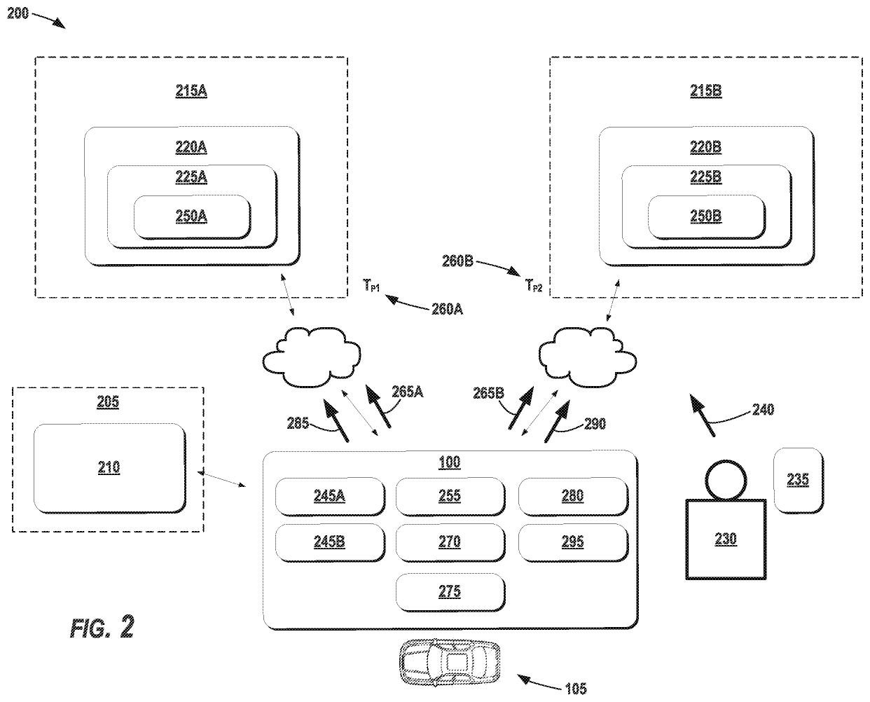

The vehicle 105 can be associated with a variety of different parties. For example, FIG. 2 depicts an example architecture 200 according to example embodiments of the present disclosure. As shown, the vehicle computing system 100 of the vehicle 105 can be configured to communicate with a plurality of different computing systems that are remote from the vehicle 105.

In some implementations, the vehicle 105 can be associated with a third party 205. The third party 205 can include, for example, an owner, a manufacturer, a vendor, a manager, a coordinator, a handler, etc. of the vehicle 105. The third party 205 can be an individual, a group of individuals, an entity (e.g., a company), a group of entities, a service entity, etc. In some implementations, the vehicle 105 can be included in a fleet of vehicles associated with the third party 205, as further described herein. The third party 205 utilize a third party computing system 210 that is remote from the vehicle 105 to communicate (e.g., over one or more wireless communication channels) with the vehicle computing system 100 of the vehicle 105. The third party computing system 210 can include a server system (e.g., of an entity), a user device (e.g., of an individual owner), and/or other types of computing systems.

The vehicle 105 can be configured to perform vehicle services for a plurality of different service entities 215A-B. A vehicle 105 can perform a vehicle service by, for example and as further described herein, travelling (e.g., traveling autonomously) to a location associated with a requested vehicle service, allowing user(s) and/or item(s) to board or otherwise enter the vehicle 105, transporting the user(s) and/or item(s), allowing the user(s) and/or item(s) to deboard or otherwise exit the vehicle 105, etc. In this way, the vehicle 105 can provide the vehicle service(s) for a service entity to a user.

A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services. The number of service entities shown in FIG. 2 is not meant to be limiting, as the plurality of service entities could include more than that shown.

Each service entity 215A-B can be associated with a respective telecommunications network 220A-B of that service entity. A telecommunications network can include the infrastructure to facilitate communication between the vehicle 105 and the various computing systems of the associated service entity that are remote from the vehicle 105. For example, a service entity 215A-B can utilize an operations computing system 225A-B of the service entity to communicate with, coordinate, and/or manage vehicle(s) to provide the vehicle services of the service entity 215A-B. The telecommunications network 220A-B can allow a vehicle 105 to utilize the back-end functionality of the operations computing system 225A-B (e.g., vehicle service assignment allocation, vehicle technical support, etc.).

An operations computing system 225A-B can include one or more computing devices that are remote from the vehicle 105 (e.g., located off-board the vehicle 105). For example, such computing device(s) can be components of a cloud-based server system and/or other type of computing system that can communicate with the vehicle computing system 100 of the vehicle 105 (and/or a user device). The operations computing system 225A-B can be a distributed across one or more location(s) and include one or more sub-systems. The computing device(s) of an operations computing system 225A-B can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system 225A-B (e.g., the one or more processors, etc.) to perform operations and functions, such as communicating data to and/or obtaining data from vehicle(s), coordinating the provision of vehicle services by vehicle(s), etc.

A user 230 can request a vehicle service from a service entity 215A-B. For example, the user 230 can provide user input to a user device 235 to request a vehicle service (e.g., via a user interface associated with a mobile software application of the service entity). The user device 235 can communicate data 240 indicative of a request for a vehicle service to an operations computing system 225A-B associated with the service entity 215A-B (and/or another associated computing system that can then communicate data to the operations computing system 225A-B). The request can indicate the type of vehicle service that the user 230 desires (e.g., a transportation service, a delivery service, a courier service, etc.), one or more locations (e.g., an origin location, a destination location, etc.), timing constraints (e.g., pick-up time, drop-off time, deadlines, etc.), one or more service parameters (e.g., a need for handicap access, a need for trunk space, etc.), and/or other information. The operations computing system 225A-B of the service entity 215A-B can process the data 240 indicative of the request and generate a vehicle service assignment that is associated with the service request. The operations computing system 225A-B can identify one or more vehicles that may be able to perform the requested vehicle services to the user 230.

An operations computing system can communicate with a vehicle 105 via the service entity's computing platform. A computing platform of a service entity 215A-B can provide the vehicle computing system 100 and the operations computing system 225A-B with a computing environment that allows the systems to communicate. A computing platform can include a variety of computer architectures. Moreover, the computing platform can include the software, hardware, application programming interface(s), etc. that are associated with the service entity 215A-B. Each service entity 215A-B may have a different computing platform that can allow the service entity's operations computing system 225A-B and the vehicle computing system 100 to communicate via the telecommunications network 220A-B associated with the service entity.

One or more of the components of a computing platform can be accessible by the vehicle computing system 100. For instance, to help communicate with the various different service entities 210A-B, a vehicle computing system 110 of the vehicle 105 can include a plurality of vehicle clients 245A-B, each associated with a different service entity 210A-B. For example, the vehicle 105 can include a first vehicle client 245A associated with a first service entity 215A and a second vehicle client 245B associated with a second service entity 215B (e.g., that is different than the first service entity 215A). A vehicle client can be a software platform component of the service entity's computing platform that is stored onboard a vehicle 105. For example, a vehicle client can include firmware, software (e.g., a software application), etc. that is stored onboard the vehicle 105 (or in an offboard memory that is accessible by the vehicle 105) and that can allow the vehicle computing system 100 to communicate data to and/or obtain data from the operations computing system 225A-B associated with a service entity 215A-B. For example, a vehicle client 245A-B can allow the vehicle computing system 100 to receive data indicative of one or more vehicle service assignments from an associated service entity 215A-B. The vehicle client 245A-B can be provided to a vehicle 105 by an operations computing system 225A-B associated with a service entity 215A-B and/or provided to a third party computing system 210 that can then help implement the vehicle client 245A-B on the vehicle 105 (e.g., by communicating a configuration to the vehicle computing system 100). In some implementations, the operations computing system 225A-B and the vehicle computing system 100 can indirectly communicate. For example, the third party computing system 210 can serve as an intermediary between the operations computing system 225A-B and the vehicle computing system 100 such that at least some data (e.g., the data described herein) is communicated from the operations computing system 225A-B (or the vehicle computing system 100) to the third party computing system 210 and then to the vehicle computing system 100 (or the operations computing system 225A-B).

A vehicle client 245A-B can be implemented via hardware and/or software onboard the vehicle 105, such that the vehicle computing system 100 can access an application programming interface 250A-B associated with a service entity 215A-B. The vehicle computing system 100 can invoke, via a vehicle client 245A-B, the application programming interface 250A-B to access a library indicative of a plurality of parameters. The library can include, for example, a central repository for parameters that can be used to generate a communication (e.g., query string, message, data set, etc.) to be sent to the service entity's operations computing system. In some implementations, each service entity 215A-B can be associated with a different application programming interface 250A-B. For example, a first service entity 215A can be associated with a first application programming interface 250A and a second service entity 215B can be associated with a second application programming interface 250B (e.g., which is different from the first application programming interface 250A). Additionally, or alternatively, one or more service entities can utilize the same application programming interface and/or the first and second application programming interfaces 250A-B can be the same (or at least similar).

Example embodiments of the present disclosure describes operations and functions performed by the onboard vehicle computing system 100 and/or the third party computing system 210 for selecting a service entity 215A-B and/or a vehicle service assignment for the vehicle 105, communicating a vehicle's availability to perform vehicle service(s), and/or operations and functions. One or more of the operations and functions described as being performed by the vehicle computing system 100 can be performed by the third party computing system 210, and vice versa, and/or any combination thereof without deviating from the scope of the present disclosure. As such, the description may include reference “computing system(s) 100/210” to reflect these various possibilities.

To help select a service entity 215A-215B for which to perform a vehicle service, the computing system(s) 100/210 can obtain data 255 associated with one or a plurality of service entities 215A-B. In some implementations, the data 255 can be obtained by one or more operations computing systems 225A-B associated with the service entities 215A-B and/or other computing system(s). Additionally, or alternatively, a vehicle computing system 100 can obtain such data from a third party computing system 210 associated with the vehicle 105 (e.g., a computing system of a vehicle vendor, vehicle owner, etc.). The data 255 associated with the one or more service entities 215A-B can include a variety of information.

In some implementations, the computing system 100/205 can select a service entity from among the plurality of different service entities 215A-B based at least in part on the various types of data associated with the service entities 215A-B. For example, the data 255 associated with the one or the plurality of service entities 215A-B can include various types of information associated with the vehicle service(s) of one or more of the different service entities. By way of example, the data 255 can obtain historic vehicle service data that is indicative of historic service trend(s) associated with a respective service entity (e.g., historic levels of demand for vehicle service(s), historic volume(s) of user requests, historic volume(s) of vehicle service assignments, historic volumes of vehicle supply for the service entity, previous events in a geographic area, etc.). Additionally, or alternatively, the data 255 can include current vehicle service data that is indicative of a current: level of demand for vehicle service(s), volume of user requests, volume of vehicle service assignments, volume of vehicle supply available to perform vehicle services for the service entity, event(s) (e.g., sporting events, concerts, etc.), and/or other information. Additionally, or alternatively, the data 255 can include future vehicle service data that is indicative of a known and/or a predicted future: level of demand for vehicle service(s), volume of user requests, current volume of vehicle service assignments, current volume of vehicle supply available to perform vehicle services for the service entity, event(s), and/or other information. In some implementations, one or more of the types of data described herein can be associated with a particular time period (e.g., certain day, month, time of day, during weekdays, during weekends, etc.) and/or geographic area.

Additionally, or alternatively, the data 255 can include vehicle service compensation data. Such data can be indicative of the historic, current, and/or future level of compensation provided by a respective service entity for its vehicle service(s). In some implementations, the compensation data can be associated with a particular time period and/or geographic area.

Additionally, or alternatively, the data 255 can include data indicative of one or more vehicle service quotas. Such data can indicate, for example, a vehicle service quota of vehicle service assignments that the vehicle 105 is supposed to address for a service entity (e.g., in a given time period), an amount of time the vehicle 105 is supposed to be available to the service entity, the progress the vehicle 105 (or its associated fleet) has made toward meeting such a vehicle service quota (e.g., how many vehicle service assignments have been made, how many are left to fill the quota, etc.), and/or other information. In some implementations, a vehicle service quota can be associated with an individual vehicle (e.g., how many transportation trips that vehicle is supposed to complete within a given month, etc.). Additionally, or alternatively, a vehicle service quota can be an aggregate quota associated with a vehicle fleet or a subset thereof (e.g., how many aggregate transportation trips the fleet or a subset thereof is to complete in a given week, etc.). In some implementations, a vehicle service quota can be associated with a particular time period and/or geographic area.

In some implementations, the data 255 can include data indicative of one or more vehicle service incentives. For example, a service entity may provide a vehicle 105 an incentive to go online with the service entity (e.g., to become available to receive vehicle service assignments and/or perform vehicle service(s) for the service entity, etc.). Such an incentive can include increased compensation, a priority on preferred vehicle service assignments (e.g., from highly rated users, etc.), an increase in vehicle rating, and/or other incentives. In some implementations, the incentive(s) can be associated with a particular time period and/or geographic area.

In some implementations, the data 255 can include data that is indicative of a preferred service entity for the vehicle 105. For example, the computing system(s) 100/210 can obtain data identifying the first service entity 210A as a preferred service entity. In some implementations, a service entity can be identified as a preferred service entity by a third party 205 associated with the vehicle 105 (e.g., in light of an agreement between the third party 205 and the service entity, etc.). In some implementations, the preferred service entity can be based on a particular time period and/or geographic area. For example, the first service entity 215A may be a preferred service entity during a first time period and/or within a first geographic area. The second service entity 215B may be a preferred service entity during a second time period and/or within a second geographic area.

The computing system(s) 100/210 can utilize the data 255 to determine a service entity 215A-B for which the vehicle 105 is to perform one or more vehicle services. For instance, the computing system(s) 100/210 can determine a first service entity 215A, of the plurality of service entities, for which the vehicle 105 is to perform at least one first vehicle service (e.g., a first transportation service that involves transporting a user from one location to another) based at least in part on the data 255 associated with the one or more service entities 215A-B. This can include determining which of the different vehicle clients 245A-B (e.g., software platforms, applications, etc.) should be utilized by the vehicle 105, determining which of the different computing platforms and/or telecommunications networks the vehicle 105 should to go online with, etc.

The computing system(s) 100/210 can include programmed logic, heuristics, models (e.g., machine-learned models), etc. that can be utilized to evaluate the data 255 associated with the one or more service entities 215A-B and to select a first service entity 215A for the vehicle 105 (e.g., select a vehicle client, computing platform, telecommunications network, etc.). By way of example, the computing system(s) 100/210 can apply an optimization function that can weigh the different types of data and provide a recommended service entity. For example, in one embodiment, the computing system(s) 100/210 can apply a first weight to route based data, a second weight to capacity data, a third weight to vehicle requirements data, and a fourth weight to safety requirements data. In some implementations, one or more of these weights can be the same. Additionally, or alternatively, one or more of these weights can be different. Additionally, or alternatively, data obtained from sensors on the vehicle can be used to apply a weight to the data. In an alternative embodiment, the computing system(s) 100/210 can apply a first weight to the historic vehicle service data, a second weight to the current vehicle service data, a third weight to the vehicle service compensation data, a fourth weight to the future vehicle service data, a fifth weight to the data indicative of the one or more vehicle service quotas, and/or a sixth weight to the data indicative of the one or more vehicle service incentives. In some implementations, one or more of these weights can be the same. Additionally, or alternatively, one or more of these weights can be different. By way of example, the optimization function can apply a greater weight to any agreed-upon quotas and/or current levels of compensation and apply lower weights to historic vehicle service data.

In some implementations, the computing system(s) 100/210 can select a service entity for a particular time period. For instance, the computing system(s) 100/210 can determine that the vehicle 105 is to perform at least one first vehicle service for the first service entity 215A during a first time period 260A. Such determination can be made, for example, by using the programmed logic, heuristics, models, etc., as described herein. By way of example, the computing system(s) 100/210 can determine that it would be advantageous for the vehicle 105 to perform delivery service(s) for a first service entity 215A during the daytime (e.g., due to a historically high number of service requests during the daytime). In some implementations, the computing system(s) 100/210 can determine that the vehicle 105 is to perform at least one second vehicle service for the second service entity 215B during a second time period 260B (e.g., using its optimization function). By way of example, the computing system(s) 100/210 can determine that the vehicle 105 should perform transportation services for a second service entity 215B during the nighttime (e.g., due to a high level of compensation).

In some implementations, the third party 205 associated with the vehicle 105 can identify the service entity and an associated time period for the vehicle 105. For instance, a third party 205 can determine a service schedule for the vehicle 105 that identifies certain service entities and time periods for the vehicle 105. The third party computing system 210 can communicate data indicative of the schedule to the vehicle computing system 100. For example, such data can indicate a first time period 260A during which the vehicle 105 is to be available to receive vehicle service assignments and/or perform vehicle service(s) for the first service entity 215A. The vehicle computing system 100 can obtain such data and determine that the vehicle 105 is to perform vehicle service(s) for the first service entity 215A during the first time period 260A (e.g., solely perform the vehicle service(s) for the first service entity 215A during that time). In some implementations, the vehicle computing system 100 can go online with only the first service entity 215A (as further described herein) during the first time period 260A such that the vehicle 105 is only available to obtain vehicle service assignments and/or perform vehicle service(s) for the first service entity 215A during that time.

Additionally or alternatively, the vehicle computing system 100 can also obtain data (e.g., from a third party computing system 210, etc.) identifying the second service entity 215B and a second time period 260B. As such, the vehicle computing system 100 can determine that the vehicle 105 is to perform at least one second vehicle service for the second service entity 215B during the second time period 260B (e.g., solely perform the vehicle service(s) for the second service entity 215B during that time). The first vehicle service can be the same or a different type of service as the second vehicle service. By way of example, based on the data obtained from the third party computing system 210, the vehicle computing system 100 can determine that the vehicle 105 is to perform transportation service(s) for the first service entity 215A during weekdays and is to perform transportation services for the second service entity 215B during weekends.

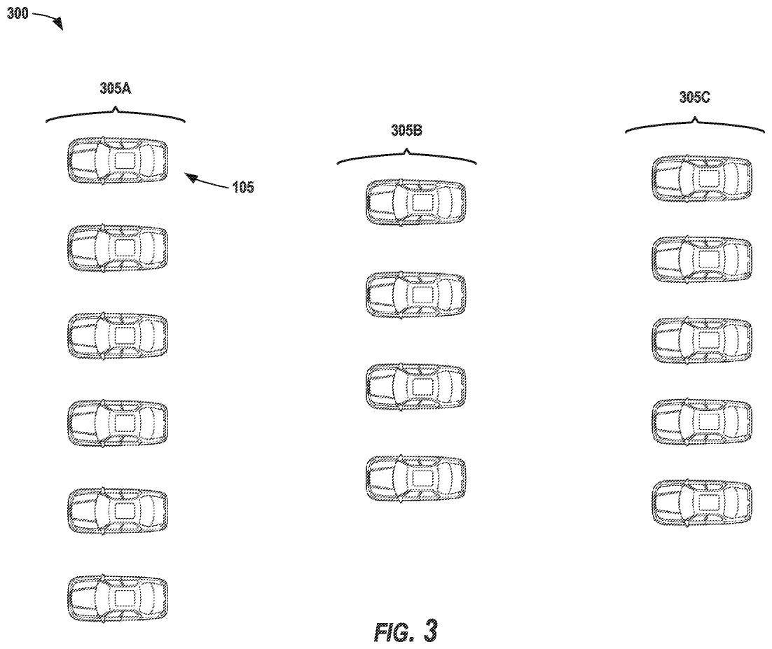

In some implementations, a third party 205 can instruct the vehicle 105 to select a certain service entity based at least in part on a vehicle fleet allocation. For instance, as shown in FIG. 3, the vehicle 105 can be included in a fleet 300 of vehicles (e.g., autonomous vehicles, etc.) associated with a third party 205. The third party 205 may decide to designate one or more portions of its fleet to different service entities. For example, the third party 205 may designate at least a first subset 305A of the fleet 300 to a first service entity 215A (e.g., based on a service level agreement with the first service entity 215A, etc.). Additionally, or alternatively, the third party 205 may designate at least a second subset 305B of the fleet 300 to a second service entity 215B. Additionally, or alternatively, the third party 205 may designate at least a third subset 305C of the fleet 300 to another service entity. In some implementations, the designations can be associated with a particular time period and/or geographic area.

The vehicle 105 can be included within the first subset 305A of the fleet 300 that is designated for the first service entity 215A. As such, the data 255 associated with the service entities (shown in FIG. 2) can include data identifying the first service entity 215A as the service entity that has been designated for the first subset 305A of the fleet 300 that includes the vehicle 105. Such data can include, for example, an instruction for the vehicle 105 to only accept vehicle service assignments from the first service entity 215A, an instruction for the vehicle 105 to go online with the first service entity 215A (e.g., launch the first vehicle client 245A, connect with the first telecommunications network 220A of the first service entity 215A, etc.), and/or other types of data. In some implementations, the data identifying the first service entity 215A can include a configuration change that allows the vehicle 105 to communicate with (e.g., obtain vehicle service assignments from, etc.) the first operations computing system 225A of the first service entity 215A. For example, the third party computing system 210 can push a service query over a wireless network to the vehicle computing system 100 instructing the vehicle 100 as to which vehicle client, computing platform, network(s), and/or operations computing system the vehicle 105 is supposed to use for the first service entity 215A. The instructions and/or configuration changes can be exclusive such that the vehicle computing system 100 can only go online with, receive/accept vehicle service assignments from, etc. the first service entity 215A.

In some implementations, the third party 205 can identify more than one service entities for which the vehicle 105 is to perform a vehicle service. For example, the data 255 associated with the service entities can include data identifying the first service entity 215A and the second service entity 215B as the service entities that have been designated for the first subset 305A of the fleet 300 that includes the vehicle 105. Accordingly, the vehicle 105 can concurrently go online with those respective service entities.

Returning to FIG. 2, the computing system(s) 100/210 can indicate that the vehicle 105 is available to perform the vehicle service(s) associated with one or more service entities. For instance, the computing system(s) 100/210 can indicate to a first remote computing system associated with the first service entity 215A (e.g., a first operations computing system 225A) that the vehicle 105 is available to perform at least one first vehicle service for the first service entity 215A. In some implementations, the third party computing system 210 can communicate (e.g., to the first operations computing system 225A) data indicating that the vehicle 105 is available to receive vehicle service assignments and/or to perform vehicle service(s) for a service entity. In some implementations, the third party computing system 210 can instruct the vehicle 105 to indicate its availability to a service entity.

The vehicle computing system 100 can indicate such availability by going online with the service entity, communicating directly with the operations computing system of the service entity (e.g., to send data indicative of the vehicle's availability, changing a vehicle status indicator, etc.), indirectly communicating the vehicle's availability to the operations computing system of the service entity (e.g., by communicating data indicative of the vehicle's availability to the third party computing system 210 that can communicate with the operations computing system of the service entity, changing a vehicle status indicator, etc.), and/or other types of indications.

The vehicle computing system 100 can go online with the computing platform and/or a first telecommunications network 220A of a first service entity 215A such that the vehicle 105 is able to communicate with the first operations computing system 225A of the first service entity. This can allow the vehicle computing system 100 to receive data indicative of one or more vehicle service assignments associated with the first service entity 215A. By way of example, as described herein, the vehicle computing system 100 can include a first vehicle client 245A associated with the first service entity 215A. The vehicle computing system 100 can indicate the vehicle's availability by launching the first vehicle client 245A. The vehicle computing system 100 can establish a first communication session with a first remote computing system associated with the first service entity 215A (e.g., the first operations computing system 225A). The communication session can be opened based at least in part on a first application programming interface 250A associated with the first service entity 215A. For instance, the vehicle computing system 100 can access, via the first vehicle client 245A, the first application programming interface 250A associated with the first selected service entity 215A. The vehicle computing system 100 can generate a first communication 265A (e.g., data string, etc.) based at least in part on the first application programming interface 250A (e.g., based on the defined parameters thereof, etc.). The first communication 265A can indicate that the vehicle 105 is available to perform at least one first vehicle service for the first service entity 215A and/or is available to obtain vehicle service assignment(s) the first service entity 215A (e.g., a computing system associated therewith). The vehicle computing system 100 can provide the first communication 265A to the first operations computing system 225A of the first service entity 215A to indicate that the vehicle 105 is online with the first service entity 215A and that the vehicle 105 is available to perform vehicle service(s) for the first service entity 215A. Additionally, or alternatively, the vehicle computing system 100 can provide the first communication 265A to the third party computing system 210, which can provide the first communication 265A (or similar such data) to the first operations computing system 225A to indicate that the vehicle 105 is online with the service entity and that the vehicle 105 is available to perform vehicle service(s) for the first service entity 215A. In some implementations, the third party computing system 210 can perform similar operations to communicate with the operations computing system of a service entity via an application programming interface.

The computing system(s) 100/210 can obtain data indicative of at least one first vehicle service assignment 270 associated with the first service entity 215A. The at least one first vehicle service assignment 270 can be indicative of at least one first vehicle service (e.g., for performance by the vehicle 105). In some implementations, the third party computing system 210 can obtain data indicative of at least one first vehicle service assignment 270 associated with the first service entity 215A. The third party computing system 210 can communicate the data indicative of at least one first vehicle service assignment 270 (or at least a portion thereof) to the vehicle computing system 100. Additionally, or alternatively, the vehicle computing system 100 can obtain, via the first communication session, the data indicative of the first vehicle service assignment 270 associated with the first service entity 215A (e.g., from the first operations computing system 225A).

The first vehicle service assignment 270 can be a candidate vehicle service assignment that can be stored in a vehicle service assignment queue, as further described herein. In some implementations, the first vehicle service assignment 270 can be a request that the vehicle 105 perform the first vehicle service. The vehicle computing system 100 may consider such a request for acceptance or rejection. In some implementations, the first vehicle service assignment 270 can be a command that the vehicle computing system 100 is required to accept, unless it is physically incapable/impaired from performing the associated vehicle service. The vehicle computing system 100 can select the first vehicle service assignment 270 and communicate data indicative of its acceptance to the first operations computing system 225A of the first service entity 215A.

The computing system(s) 100/210 can cause the vehicle 105 to initiate a first motion control in accordance with the first vehicle service assignment 270. By way of example, the first vehicle service assignment 270 can indicate that the vehicle 105 is to transport a user from an origin location to a destination location within a certain timeframe. The first vehicle service assignment 270 can indicate a compensation parameter, any incentives associated with the transportation service assignment, and/or other information. In some implementations, the third party computing system 210 can communicate data to the vehicle computing system 100 to cause the vehicle 105 to initiate a motion control in accordance with the first vehicle service assignment. This can include, for example, data indicative of a route for the vehicle 105 to follow from its current location to the origin location and then to the destination location. In some implementations, the vehicle computing system 100 can cause the vehicle 105 to initiate a motion control (e.g., via an onboard autonomy system and the vehicle's control systems, etc.) in accordance with the first vehicle service assignment 270. By way of example, the autonomy computing system 130 can communicate signals to the vehicles control system(s) 135 to cause the vehicle 105 to autonomously travel to the origin location of the user to be transported.

In some implementations, the computing system(s) 100/210 can determine a second service entity 215B, of a plurality of service entities 215A-B, for which the vehicle 105 is to perform at least one second vehicle service (e.g., a second transportation service). The computing system(s) 100/210 can indicate, to a second remote computing system associated with the second service entity 215B (e.g., the second operations computing system 225B), that the vehicle 105 is available to perform the at least one second vehicle service for the second service entity 215B. By way of example, the third party computing system 210 can communicate data indicative of the vehicle's availability to the second operations computing system 225B of the second service entity 215B. Additionally, or alternatively, the vehicle computing system 100 can establish a second communication session with a second remote computing system associated with the second service entity 215B (e.g., the second operations computing system 225B). For example, the vehicle computing system 100 can access, via the second vehicle client 245B, a second application programming interface 250B associated with the second service entity 215B. The vehicle computing system 100 can generate a second communication 265B based at least in part on the second application programming interface 250B. The second communication 265B can indicate that the vehicle 105 is available to perform the at least one second vehicle service for the second service entity 215B. In some implementations, the second communication session can be established concurrently with the first communication session. In some implementations, the vehicle computing system 100 can terminate the first communication session with the first remote computing system associated with the first service entity 215A (e.g., the first operations computing system 225A). For example, the vehicle computing system 100 can establish the second communication session with the second remote computing system (e.g., the second operations computing system 225B) after terminating the first communication session with the first remote computing system (e.g., the first operations computing system 225A). This can occur, for example, in the event that the vehicle 105 is to solely perform vehicle service(s) to a certain service entity (e.g., during a time period set by a third party, during a time period determined by the vehicle itself, etc.). In another example, the vehicle computing system 100 can terminate the second communication session in favor of another. In some implementations, the computing system(s) 100/210 can wait until after the first time period 260A and/or after a first communication session is terminated to indicate that the vehicle 105 is available to perform vehicle service(s) for another service entity.

The computing system(s) 100/210 can obtaining data indicative of at least one second vehicle service assignment 275 associated with the second service entity 215B. The at least one second vehicle service assignment 275 can be indicative of at least one second vehicle service to be performed for the service entity (e.g., a second requested transportation service). For example, the third party computing system 210 can obtain data indicative of the second vehicle service assignment 275. In some implementations, the third party computing system 210 can communicate such data to the vehicle 105. Additionally, or alternatively, the vehicle computing system 100 can obtain, via the second communication session, data indicative of the second vehicle service assignment 275 associated with the second service entity 215B. The vehicle 105 can initiate a second motion control for the vehicle 105 in accordance with the second vehicle service assignment, in a similar manner as described herein.

Example aspects of the present disclosure can enable a vehicle 105 to better select a vehicle service assignment from among a plurality of candidate vehicle service assignments. For instance, the computing system(s) 100/210 can indicate to a plurality of service entities 215A-B that the vehicle 105 is available to perform one or more vehicle services for the service entities 215A-B. As described herein, this can include the third party computing system 210 communicating data to the operations computing systems 225A-B to indicative the vehicle's availability. Additionally, or alternatively, this can include the vehicle computing system 100 going online with the respective computing platform/telecommunications network of each of the service entities 215A-B. For example, the vehicle computing system 100 can establish a plurality of communication sessions with a plurality of remote computing systems (e.g., operations computing systems), each associated with a different service entity. The vehicle computing system 100 can indicate, via the first vehicle client 245A, to a first remote computing system associated with the first service entity 215A (e.g., the first operations computing system 225A) that the vehicle 105 is available to perform one or more vehicle services (and/or obtain vehicle service assignments). Additionally, or alternatively, the vehicle computing system 100 can indicate, via the second vehicle client 245B, to a second remote computing system associated with the second service entity 215B (e.g., the operations computing system 225B) that the vehicle 105 is available to perform one or more vehicle services (and/or obtain vehicle service assignments). The vehicle computing system 100 can utilize other vehicle clients to indicate to other service entities that the vehicle 105 is available to perform vehicle service(s) and/or obtain vehicle service assignments, from those other service entities.

The computing system(s) 100/210 can obtain data 280 associated with a plurality of candidate vehicle service assignments (e.g., via the networks, communication sessions, etc.). Each of the candidate vehicle service assignments can be associated with a different service entity of the plurality of service entities. In some implementations, a plurality of candidate vehicle assignments may be provided by a single service entity.

The computing system(s) 100/210 can communicate the data 280 indicative of the plurality of candidate vehicle service assignments for storage in a memory. FIG. 4A depicts a vehicle service assignment queue 450 according to an embodiment of the present disclosure. The vehicle service assignment queue 450 can be a data structure (e.g., table, matrix, list, etc.) that is indicative of a plurality of candidate vehicle service assignments 455A-E. In some implementations, at least a portion of the data 280 indicative of the plurality of candidate vehicle service assignments 455A-E can be stored in the vehicle service assignment queue 450 in a memory that is offboard the vehicle 105 (e.g., in a memory associated with the third party computing system 210). Additionally, or alternatively, the vehicle computing system 100 can store at least a portion of the data 280 associated with the plurality of candidate vehicle service assignments in a candidate vehicle service assignment queue in a memory onboard the vehicle 105.

The computing system(s) 100/210 can be configured to analyze the plurality of candidate vehicle service assignments 455A-E to select at least one for the vehicle 105. Preferably, the selection is based on a physical attribute of the autonomous vehicle 105. The data 280 associated with the plurality of vehicle service assignments 455A-E can include data indicative of a specific attribute, such as a physical attribute, required of the vehicle 105 in order for the vehicle 105 to undertake a candidate vehicle service requirement. For instance, candidate vehicle service assignment G 455B corresponds to a delivery of a package. The ability of a vehicle to deliver a package will depend, in part, on the size of the package and the available space in the vehicle to carry the package. For example a parcel may require approximately 101×10×48cm of space within the vehicle 105. Sensors such as cameras and/or weight sensors on board the vehicle can be used to determine the free space available within the vehicle 105. As such, candidate vehicle service assignment G 455B would be selected by a vehicle detected to have sufficient carrying capacity for the package. In a further example, candidate vehicle service assignment H 455C corresponds to a transportation assignment requiring handicap access. As such, this candidate vehicle service assignment should be selected by a vehicle determined to be able to accommodate such passengers. The determination can be based on a physical attribute of the vehicle (e.g., whether or not the vehicle is equipped to carry disabled passengers), and can also be based on a current state of the vehicle (e.g., if the vehicle is presently carrying the maximum allowable number of disabled passengers). Preferably, the vehicle is equipped with sensors to detect the current physical attributes or state of the vehicle. As such, the determination can be based on data indicative of the vehicle requirements. In yet another example, candidate vehicle service assignment I 455D corresponds to a transportation assignment request for three adults and one child. As such, this candidate vehicle service assignment should be selected by a vehicle detected to have suitable safety features for carrying a child passenger. As such, the determination can be based on data indicative of safety requirements.

The computing system(s) 100/210 can determine a selected vehicle service assignment based at least in part on the data 280 associated with the plurality of candidate vehicle service assignments 455A-E. For instance, the computing system(s) 100/200 can apply an optimization function that weighs the various types of data. In some implementations, the weights of each type of data can change based on attributes of the vehicle 105. By way of example, the vehicle 105 may be equipped to carry handicapped or disabled passengers, and so the optimization function (e.g., utilized by the vehicle computing system 100, third party computing system 210, etc.) may apply a higher weight to any parameters indicating that handicap access is required. In the example shown in FIG. 4A, the computing system(s) 100/210 may determine that candidate vehicle service assignment H 455C should be the selected vehicle service assignment for the vehicle 105. Beneficially, this helps to ensure efficient usage of resources, since vehicles able to accommodate disabled passengers are prioritized to vehicle service assignment requests requiring disabled or handicapped access. In further implementations, the weights of each type of data can be dynamically changed based on sensor data obtained from the vehicle 105. By way of example, the vehicle 105 may have a maximum weight limit and be equipped with sensors to detect the current weight of all passengers and cargo. This sensor data can then be used to apply a dynamic weight to types of data. For example, if the sensor data indicates that the vehicle 105 is already carrying close to its maximum weight capacity, then this can result in a lower weight being applied to any parameters indicating that more passengers are required (e.g., candidate vehicle service assignment J 455E) whereas parameters which indicate that no real change to the weight of the vehicle will occur will be given a higher weight within the optimization algorithm (e.g., candidate vehicle service assignment G 455B).

In some implementations, cameras equipped within the vehicle can be used to provide real-time passenger capacity of the autonomous vehicle in order to dynamically weigh each type of data. By way of example, if the vehicle has a carrying capacity of four adults and is currently undertaking a vehicle service assignment which was listed as involving the transportation of two passengers, then cameras within the vehicle can be used to determine the actual number of passengers present within the vehicle, as the number of passengers may have been inaccurately recorded (e.g., due to extra people joining the original party of passengers). The camera sensor data can then be used to provide a dynamic weighing to the data such that parameters which keep the number of passengers being transported below the carrying capacity of four adults are assigned a higher weight.

In some implementations, the vehicle can use other factors such as current travel range, fuel consumption, and charge points along the route in order to weigh each type of data. By way of example, if the vehicle has a current range of 100 KM until refueling is required, then a higher weight can be assigned to any parameters indicating that a candidate vehicle service assignment requires a total travel distance of less than 100 KM. In the example shown in FIG. 4A, a high weight may be assigned to location for candidate vehicle service assignment F 455A since the vehicle has a current range of 100 KM, and the distance between the current location of the vehicle and the stadium, along with the distance between the stadium and hotel C, is less than 100 KM. In a further example, if the vehicle requires refueling, then a higher weight can be applied to any parameter indicating that a charge point exists on the route. In the example shown in FIG. 4A, a high weight can be assigned to the location of candidate vehicle service assignment G 455B since the vehicle is low on fuel and there is a charge point on the route between the current location of the vehicle and 3 Harper Close.

FIG. 4B depicts an example vehicle service assignment queue 400 according to a further embodiment of the present disclosure. The vehicle service assignment queue 400 can be a data structure (e.g., table, matrix, list, etc.) that is indicative of a plurality of candidate vehicle service assignments 405A-C. In some implementations, at least a portion of the data 280 indicative of the plurality of candidate vehicle service assignments 405A-E can be stored in the vehicle service assignment queue 400 in a memory that is offboard the vehicle 105 (e.g., in a memory associated with the third party computing system 210). Additionally, or alternatively, the vehicle computing system 100 can store at least a portion of the data 280 associated with the plurality of candidate vehicle service assignments in a candidate vehicle service assignment queue in a memory onboard the vehicle 105.

The computing system(s) 100/210 can be configured to analyze the plurality of candidate vehicle service assignments 405A-E to select at least one for the vehicle 105. For instance, the data 280 associated with the plurality of vehicle service assignments 405A-E can include data indicative of a compensation parameter for each respective candidate vehicle service assignment (e.g., the compensation for delivering an item to a user, couriering an item for a user, transporting a user, etc.), data indicative of one or more locations associated with each respective candidate vehicle service assignment (e.g., origin location, destination location, intermediate location, etc.), data indicative of a type of vehicle service associated with each respective vehicle assignment (e.g., transportation service, delivery service, courier service, etc.), data indicative of one or more time constraints associated with each respective vehicle assignment (e.g., pick-up times, drop-off times, time limits for delivery, service duration, etc.), data indicative of an order in which each vehicle service assignment was obtained by the autonomous vehicle, data indicative of one or more vehicle service parameters associated with one or more of the vehicle service assignments (e.g., luggage, handle-with-care instructions, special pick-up requests, etc.), data indicative of one or more vehicle service incentives associated with one or more of the candidate vehicle service assignments 405A-E, and/or other types of data.

The computing system(s) 100/210 can determine a selected vehicle service assignment based at least in part on the data 280 associated with the plurality of candidate vehicle service assignments 405A-E. For instance, the computing system(s) 100/210 can apply an optimization function that weighs the various types of data. In some implementations, the weights of each type of data can change based on the time of day, the status of the vehicle, and/or other factors. By way of example, the vehicle 105 may be owned by a third party individual that makes the vehicle 105 available to a plurality of service entities while the individual is at work. The optimization function (e.g., utilized by the vehicle computing system 100, third party computing system 210, etc.) may apply a higher weight to the compensation parameter during the daytime. Thus, the computing system(s) 100/210 may determine that candidate vehicle service assignment 405A and/or candidate vehicle service assignment 405E should be the selected vehicle service assignment for the vehicle 105 (e.g., the candidate vehicle service assignments with the highest compensation parameters). The optimization function may apply a higher weight to the location(s) (e.g., destination location, etc.) and/or time constraint(s) (e.g., vehicle service duration, etc.) during the end of the day when the third party individual may need the vehicle 105 to pick-up the individual from the individual's workplace at a certain time. Thus, the computing system(s) 100/210 may determine that candidate vehicle service assignment 405B should be the selected vehicle service assignment for the vehicle 105 in the event that the individual's workplace is nearby the train station (e.g., the destination location of vehicle service assignment 405B). In this way, the computing system(s) 100/210 can determine a selected vehicle service assignment from among the plurality of candidate vehicle service assignments 405A-E associated with the different service entities.

In some implementations, the computing system(s) 100/210 can obtain data indicative of a preferred service entity (e.g., as identified by a third party) to consider when evaluating the candidate vehicle service assignments. For example, the computing system(s) 100/210 can obtain data indicative of a preferred service entity. As described herein, the preferred service entity may be a service entity with which the third party 205 associated with the vehicle 105 has an arrangement with, a service entity that may be preferable during a certain time period (e.g., a service entity that is historically busy during the weekends), a service entity that may be preferable within a certain geographic area (e.g., a service entity that is historically favored by the residents of that geographic area), etc. The computing system(s) 100/210 can determine the selected vehicle service assignment based at least in part on the data indicative of the preferred service entity. For example, the computing system(s) 100/210 can determine that the candidate vehicle service assignment 405C should be the selected vehicle service assignment for the vehicle 105 in the event that “service entity 3” is a preferred service entity (e.g., at that time, within that geographic area, etc.).

Returning to FIG. 2, the computing system(s) 100/210 can indicate to the service entity associated with the selected vehicle service assignment that the vehicle 105 will address (e.g., provide, perform, undertake, etc.) the selected vehicle service assignment. For instance, the computing system(s) 100/210 can communicate data 285 indicative of an acceptance of the selected vehicle service assignment. Such data can be communicated (directly or indirectly) to a remote computing system associated with the service entity that is associated with the selected vehicle service assignment (e.g., the first operations computing system 225A of the first service entity 215A). The data 285 indicative of the acceptance can be, for example, a communication formulated based at least in part on an application programming interface associated with the service entity (e.g., a data message structured using API parameters to indicate the acceptance, etc.). By way of example, the vehicle computing system 100 can communicate (e.g., to the first operations computing system 225A of the first service entity 215A) a message indicating that the vehicle 105 will perform the requested transportation service for the user indicated in the candidate vehicle service assignment 405A.

In some implementations, the computing system(s) 100/210 can indicate to the other service entities that it did not select the vehicle service assignments associated with those service entities. For instance, the computing system(s) 100/210 can send data 290 indicative of one or more rejections of the one or more candidate vehicle service assignments that are not the selected vehicle service assignment to the operations computing systems of the associated service entities (e.g., the operations computing system 225B of the second service entity 215B). Additionally, or alternatively, the computing system(s) 100/210 can indicate to each service entity other than the service entity associated with the selected vehicle assignment that the vehicle 105 is unavailable to the respective service entity. This can include, for example, the third party computing system 210 communicate data indicating that the vehicle 105 is unavailable and/or changing a status indicator (e.g., from available to unavailable). Additionally, or alternatively, the vehicle computing system 100 can go offline with respect to those service entities (e.g., terminate the respective communication sessions with the operations computing systems of those service entities, closing a vehicle client, otherwise disconnecting from a computing platform/network, etc.), adjusting a status indicator associated with the vehicle 105 (e.g., to an unavailable status while maintaining the communication session, etc.), communicating data to those service entities to indicate that the vehicle 105 is unavailable, and/or other approaches.

The vehicle 105 can travel to address the selected vehicle service assignment. For instance, as described herein, the computing system(s) 100/210 can cause the vehicle 105 to initiate a motion control in accordance with the selected vehicle service assignment. By way of example, the third party computing system 210 can provide data instructing the vehicle 105 to travel to an origin location associated with the selected vehicle service assignment. In some implementations, this can include a route for the vehicle 105 to follow. Additionally, or alternatively, the vehicle computing system 100 can communicate a set of data to cause the vehicle 105 to initiate travel to a location associated with the selected vehicle service assignment. By way of example, the autonomy computing system 130 of the vehicle 105 can communicate (e.g., send, transfer, transmit, make available to, etc.) one or more signals to the vehicle control systems 135 of the vehicle 105 such that the vehicle 105 autonomously travels to an origin location to pick-up a user and to a destination location to drop-off the user for a transportation service request. Following completion of the selected vehicle service assignment, the computing system(s) 100/210 can indicate to each service entity of the plurality of service entities that the vehicle 105 is available to perform vehicle service(s) for the service entities, as described herein.

In some implementations, the computing system(s) 100/210 can be configured to pre-broadcast the availability of the vehicle 105 to a plurality of service entities. This can allow the computing system(s) 100/210 to pre-emptively obtain vehicle service assignments across different service entities (and their associated computing platforms).

By way of example, the vehicle 105 can be addressing a current task associated with the vehicle 105 and/or otherwise be in a state where the vehicle 105 is unavailable to currently perform one or more vehicle services for one or more service entities (e.g., de-activated, offline, etc.). In some implementations, the current task can include addressing a current vehicle service assignment for a first service entity 215A (e.g., transporting a user). In some implementations, the current task can include receiving maintenance, receiving fuel, charging an electric power source of the vehicle 105, etc. The computing system(s) 100/210 can obtain data 295 associated with a status of the vehicle 105. This can include the computing system(s) 100/210 obtaining data indicative of a status of a current task associated with the vehicle 105. By way of example, the current task can include a current vehicle service assignment and the computing system(s) 100/210 can obtain data indicating how long until the vehicle 105 will complete a current vehicle service assignment (e.g., how long until the vehicle drops-off a user at a destination location).

The computing system(s) 100/210 can determine that the vehicle 105 is to become available to perform one or more vehicle services at a later time based at least in part on the data 295 associated with the status of the vehicle 105. For instance, the computing system(s) 100/210 can determine that the vehicle is to become available at a later time based at least in part on the status of the vehicle's current task. In some implementations, this determination can be made prior to the completion of the current task associated with the vehicle 105.

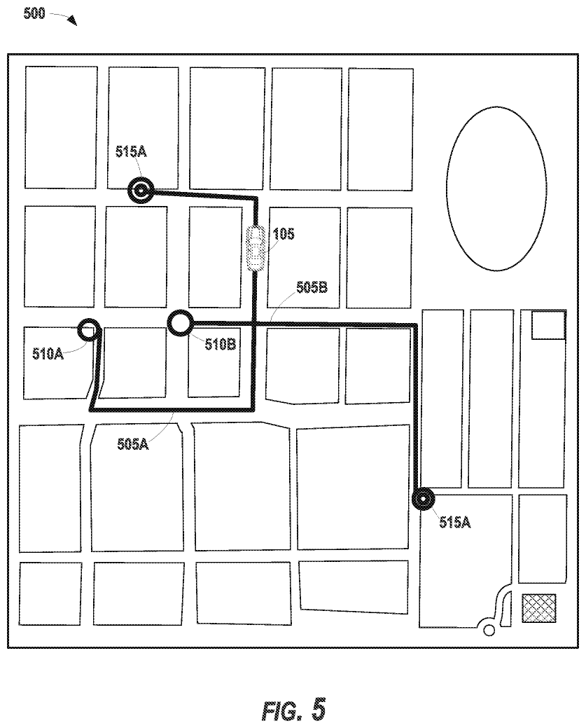

By way of example, FIG. 5 depicts a geographic area 500 in which the vehicle 105 can be travelling according to example aspects of the present disclosure. The vehicle 105 can be travelling along a first route 505A to address a current vehicle service assignment for the first service entity 215A. For example, the current vehicle service assignment can be to transport a user from a first origin location 510A to a first destination location 515A. The computing system(s) 100/210 can determine that the vehicle 105 is to become available (at a later time) based at least in part on a status of the current vehicle service assignment. In some implementations, the third party computing system 210 can monitor the location of the vehicle 105 (e.g., based on real-time location data communicated from the vehicle's positioning system, etc.) to determine the status of the current vehicle service assignment (e.g., how much progress the vehicle 105 has made toward the completion of the assignment, how long until the vehicle has completed the first vehicle service assignment, etc.). Additionally, or alternatively, the vehicle computing system 100 can determine the status of the current vehicle service assignment based on the vehicle's location (e.g., using the positioning system) and the time until the vehicle 105 will arrive at its destination. Based on such information, the computing system(s) 100/210 can determine (e.g., prior to completion of the first vehicle service assignment) that the vehicle 105 will soon arrive at the first destination location 515A for the current vehicle service assignment (e.g., a current transportation service assignment) and will become available for another vehicle service assignment at a later time that corresponds with/is shortly after the arrival of the vehicle 105 at the first destination location 515A. In another example, the computing system(s) 100/210 can obtain data associated with the vehicle 105 (e.g., health and maintenance data) to determine that the vehicle maintenance, re-fueling, re-charging, etc. will be completed shortly.

The computing system(s) 100/210 can indicate to one or a plurality of service entities that the vehicle 105 is to become available to the one or the plurality of service entities (e.g., to perform one or more vehicle services for the service entities). The computing system(s) 100/210 can indicate to one or more service entities that the vehicle 105 is to become available, prior to the completion of the vehicles current task. By way of example, the vehicle 105 can be addressing a current task associated with a first service entity 215A. This can be, for instance, a first vehicle service assignment (e.g., transporting a user from a first origin location 510A to a first destination location 515A) for the first service entity 512A. Prior to completion of the first vehicle service assignment, the computing system(s) 100/210 can indicate to one or a plurality of service entities that the vehicle 105 is to become available for another vehicle service assignment at a later time. This indication can be communicated to the first service entity 215A and/or one or more other service entities (e.g., the second service entity 215B). For example, the third party computing system 210 can communicate data indicating the vehicle's future availability, to a plurality of operations computing systems of a plurality of service entities. Additionally, or alternatively, the vehicle computing system 100 can communicate that the vehicle 105 will become available to perform vehicle(s) and/or for another vehicle service assignment at a later time. For instance, the vehicle computing system 100 can go online with the plurality of service entities (e.g., by establish a plurality of communication sessions with the associated operations computing systems, etc.), communicate data to the service entity (e.g., the associated operations computing systems, etc.) and/or other approaches to indicate the vehicle's upcoming availability. In some implementations, the computing system(s) 100/210 can provide a time (e.g., estimated time, estimated amount of time, etc.) when the vehicle 105 will become available and/or able to accept a vehicle service assignment. This can be based at least in part on an estimated time of completion of a current vehicle task (e.g., estimated drop-off time, estimated completion of maintenance, re-fueling, re-charging, etc.).

In response to indicating the vehicle's upcoming availability, the computing system(s) 100/210 can obtain data associated with one or more candidate vehicle service assignments. As described herein, each of the one or more candidate vehicle service assignments can include a request for the vehicle 105 to perform one or more vehicle services for an associated service entity. At least one (and/or each of) the candidate vehicle service assignments can be associated with a different service entity of the plurality of service entities than the other candidate vehicle service assignments. Additionally, or alternatively, one or more of the candidate vehicle service assignments can be associated with a different service entity than the service entity that is associated with the vehicle's current task (e.g., the first service entity 215A associated with the current vehicle service assignment). The computing system(s) 100/210 can obtain the data associated with one or more candidate vehicle service assignments prior to completion of the vehicle's current task.

The vehicle computing system can select a vehicle service assignment for the vehicle 105 to address. For instance, computing system(s) 100/210 can determine a selected vehicle service assignment based at least in part on the data associated with the one or the plurality of candidate vehicle service assignments. Such determination can be made prior to completion of the current task associated with the vehicle 105 (e.g., prior to dropping-off the user at the first destination location 515A in accordance with the first vehicle service assignment). The selected vehicle service assignment can be associated with a second service entity 215B that is different than the first service entity 215A (e.g., associated with the vehicle's current task). Moreover, the selected vehicle assignment can include the same or a different type of vehicle service as the current vehicle service assignment.

The computing system(s) 100/210 can determine the selected vehicle service assignment, for example, using one or more of the processes described herein. By way of example, in one embodiment the computing system(s) 100/210 can apply an optimization function that includes applying a higher weight to certain aspects of the candidate vehicle service parameter such as, for example, the physical vehicle requirements, etc. By way of example, in a different embodiment, the computing system(s) 100/210 can apply an optimization function that includes a higher weight to certain aspects of the candidate vehicle service parameter such as, for example, the compensation parameter of the vehicle service assignment, etc. The computing system(s) 100/210 can determine the selected vehicle service assignment based at least in part on a compensation parameter associated with the selected vehicle service assignment (e.g., selecting the vehicle service assignment with the highest level of compensation).

In some implementations, the computing system(s) 100/210 can determine the selected vehicle assignment based at least in part on the current task of the vehicle 105. For instance, the computing system(s) 100/210 can determine the selected vehicle service assignment based at least in part on at least one of an origin location associated with the selected vehicle service assignment or a destination location associated with the selected vehicle service assignment. By way of example, with reference to FIG. 5, the selected vehicle service assignment can be a transportation service assignment that has a second origin location 510B (e.g., pick-up location) in the vicinity of the first destination location 515A (e.g., drop-off location) of a first vehicle service assignment currently being addressed by the vehicle 105. The computing system(s) 100/210 may choose this transportation service assignment so that the computational and energy resources of the vehicle 105 are not wasted as the vehicle 105 transitions from one vehicle service assignment to another.

The computing system(s) 100/210 can accept the selected vehicle service assignment (associated with the second service entity 215B). Such acceptance can occur prior to the completion of the vehicle's current task (e.g., a current vehicle service assignment). For instance, the computing system(s) 100/210 can communicate data indicative of an acceptance of the selected vehicle service assignment to a remote computing system associated with the second service entity 215B (e.g., the operations computing system 225B associated with the second service entity 215B). The computing system(s) 100/210 can communicate the data indicative of the acceptance of the selected vehicle service assignment prior to completion of the current vehicle task (e.g., the current vehicle service assignment for the first service entity 215A). As similarly described herein, the computing system(s) 100/210 can cause the vehicle 105 to initiate a motion control in accordance with the selected vehicle service assignment (e.g., after completion of the current vehicle service assignment).

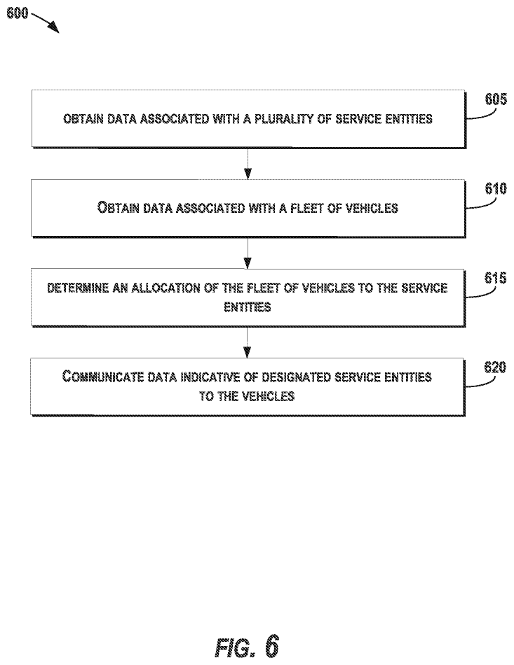

FIG. 6 depicts a flow diagram of an example method 600 for allocating a vehicle fleet according to example embodiments of the present disclosure. One or more portion(s) of the method 600 can be implemented by a computing system that includes one or more computing devices such as, for example, the computing systems described with reference to the other figures herein (e.g., the third party computing system 210). Each respective portion of the method 600 can be performed by any (or any combination) of one or more computing devices. Moreover, one or more portion(s) of the method 600 can be implemented as an algorithm on the hardware components of the device(s) described herein (e.g., as in FIGS. 1, 2, and/or 10), for example, to allocate a fleet of vehicles. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for example illustrated purposes and is not meant to be limiting. One or more portions of method 600 can be performed additionally, or alternatively, by other systems. Moreover, the vehicles referred to in the description of the method 600-900 can be autonomous vehicles.

At (605), the method 600 includes obtaining data associated with a plurality of service entities. For instance, a computing system (e.g., the third party computing system 210) can obtain data associated with a plurality of service entities. As described herein, the data associated with the plurality of service entities can include at least one of the following for a respective service entity: historic vehicle service data (e.g., historic levels of demand for vehicle service(s), historic volume(s) of user requests, historic volume(s) of vehicle service assignments, historic volumes of vehicle supply for the service entity, previous events in a geographic area, etc.); current vehicle service data (e.g., current: levels of demand for vehicle service(s), volume of user requests, volume of vehicle service assignments, volume of vehicle supply available to perform vehicle services for the service entity, events, etc.); future vehicle service data (e.g., known and/or a predicted future; levels of demand for vehicle service(s), volume of user requests, volumes of vehicle service assignments, volumes of vehicle supply available to perform vehicle services for the service entity, events, etc.). Additionally, or alternatively, the data associated with the plurality of vehicle service entities can include vehicle service compensation data, data indicative of one or more vehicle service quotas, data indicative of one or more vehicle service incentives. Additionally, or alternatively, the data associated with the plurality of service entities can be indicative of a variety of other information for each of the service entities. This can include, for example, an identifier (e.g., a name, serial number, code, other identifier, etc.) associated with a respective service entity, data indicative of an agreement associated with a respective service entity (e.g., service level agreement between the service entity and the third party), data indicative of a number of vehicles requested, needed, preferred, demanded, etc. by a respective service entity, and/or other information.

At (610), the method 600 includes obtaining data associated with a fleet of vehicles. For instance, the computing system (e.g., the third party computing system 210) can obtain data associated with a fleet of vehicles (e.g., autonomous vehicles). The fleet of vehicles can include a plurality of vehicles (e.g., autonomous vehicles) that are associated with a third party. The third party may own, lease, control, operate, manage, manufacture, etc. the fleet of vehicles. The data associated with the fleet of vehicles can be indicative of a variety of information associated with the respective vehicles in the fleet. This can include, for instance, data indicative of an identifier associated with a respective vehicle, data indicative of the location of a respective vehicle, data indicative of the state (e.g., online, offline, etc.) of the respective vehicle, data indicative of a status of a current task being performed by a respective vehicle, data indicative of any maintenance needs/schedules of a respective vehicle, and/or other information. The data associated with the fleet of vehicles can also be indicative of the size, shape, type, capacity, etc. of a vehicle. Moreover, the data associated with the fleet of vehicles can be indicative of a number of vehicles within the fleet.

At (615), the method 600 includes determining an allocation of the fleet of vehicles to the service entities. For instance, the computing system (e.g., the third party computing system 210) can determine an allocation of one or more vehicles within the fleet of vehicles to one or more service entities. The computing system can make such a determination based at least in part on heuristics, machine-learned models, algorithms, and/or other analytical approaches that are written and/or trained to recommend an optimal allocation of the fleet of vehicles across the different service entities. For example, the computing system can determine that the third party has agreed to designate a certain number of vehicles exclusively to a first service entity during a certain time period (e.g., during the weekend, etc.). Accordingly, the computing system can determine that the certain number of vehicles is to be designated to perform vehicle service(s) for the first service entity during that certain time period. In another example, the computing system can determine that a particular service entity has, is, and/or will be experiencing a high level of demand for its associated vehicle service(s) (e.g., a high level of service requests from users). Accordingly, the computing system can determine that at least a subset of its fleet of vehicles should be designated to perform vehicle service(s) for at least that particular service entity (e.g., at least during the high demand timeframe).

In another example, the computing system can allocate different subsets of its fleet to different service entities. For example, the computing system can determine that a first service entity is experiencing a high volume of service requests within a first geographic area and that a second service entity is providing a high level of compensation for vehicle service assignments in a second geographic area. The computing system can determine that a first subset of the fleet of vehicles should be designated to perform vehicle services for the first service entity in the first geographic area and that a second subset of the fleet of vehicles should be designated to perform services for the second service entity in the second geographic area.

In some implementations, the computing system can determine that one or more vehicles in the fleet of vehicles should go online with two different service entities during a concurrent time period. For example, the computing system can determine that a first service entity and a second service entity will likely receive a high volume of service requests because of a sporting event that will occur. The computing system can determine that one or more of the vehicles in the fleet should go online with the first service entity and the second service entity (at a concurrent time period) so that the vehicle is available to obtain vehicle service assignments from both the first service entity and the second service entity.

At (620), the method 600 can include communicating data indicative of the designated service entities to the vehicles. For instance, the computing system (e.g., the third party computing system 210) can communicate data indicative of a designated service entity to at least one vehicle in the fleet of vehicles. The vehicle computing system of the at least one vehicle can obtain the data indicative of the designated service entity. Based on such data, the vehicle computing system can identify the service entity with which the vehicle is supposed to go online. This can include the identification of the vehicle client (e.g., software platform), computing platform, telecommunications network, application programming interface, etc. associated with the service entity. The vehicle computing system can go online with the designated service entity (e.g., launch a vehicle client, establish a communications sessions, etc.) so that the vehicle computing system can obtain data indicative of vehicle service assignment(s) from a computing system associated with the designated service entity (e.g., the first service entity). In the event that the vehicle is designated to the service entity for a certain time period, the vehicle can go online with that service entity for that certain time period. Additionally, or alternatively, in the event that the vehicle is designated for more than one service entity, the vehicle computing system can go online with respect to each of the designated service entities (e.g., the first service entity and the second service entity). This can allow the vehicle computing system to obtain vehicle service assignments and/or perform vehicle services for each of the designated service entities.

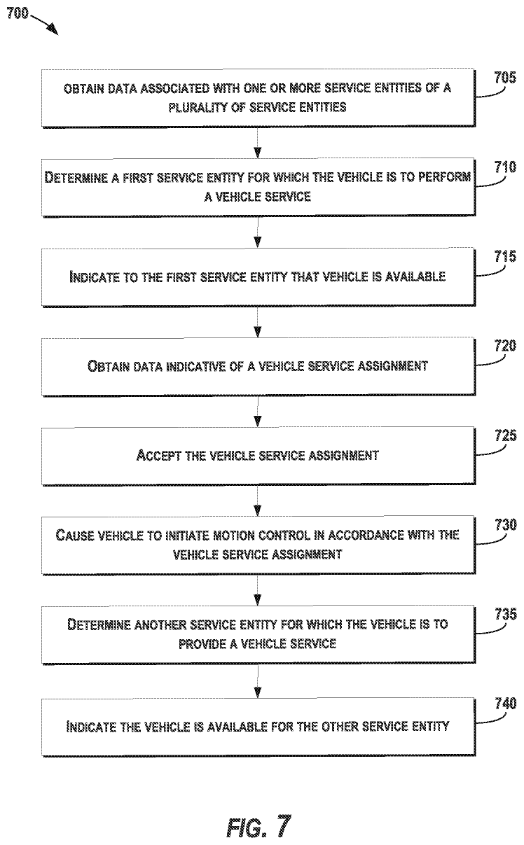

FIG. 7 depicts a flow diagram of an example method 700 for controlling vehicles (e.g., autonomous vehicles) according to example embodiments of the present disclosure. One or more portion(s) of the method 700 can be implemented by a computing system that includes one or more computing devices such as, for example, the computing systems described with to the other figures (e.g., the vehicle computing system 100, the third party computing system 210, etc.). Each respective portion of the method 700 can be performed by any (or any combination) of one or more computing devices. Moreover, one or more portion(s) of the method 700 can be implemented as an algorithm on the hardware components of the device(s) described herein (e.g., as in FIGS. 1, 2, and/or 10), for example, to control one or more vehicles (e.g., autonomous vehicles). FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for example illustrated purposes and is not meant to be limiting. One or more portions of method 700 can be performed additionally, or alternatively, by other systems.

At (705), the method 700 can include obtaining data associated with one or a more service entities of a plurality of service entities. For instance, a computing system (e.g., the vehicle computing system 100 onboard the vehicle 105, the third party computing system 210, etc.) can obtain data associated with a plurality of service entities. Each service entity can be associated with a provision of one or more vehicle services (e.g., transportation services, delivery services, courier services, etc.). As described herein, the data associated with the plurality of service entities can include at least one of historic vehicle service data, current vehicle service data, vehicle service compensation data, future vehicle service data, data indicative of one or more vehicle service quotas, and/or data indicative of one or more vehicle service incentives.

At (710), the method 700 can include determining a first service entity for which a vehicle is to perform a vehicle service. For instance, the computing system (e.g., the vehicle computing system 100 onboard the vehicle 105, the third party computing system 210, etc.) can determine, based at least in part on the data associated with the plurality of service entities, a first service entity of the plurality of service entities for which a vehicle (e.g., an autonomous vehicle) is to perform a first vehicle service. The computing system can select the first service entity for the vehicle (e.g., so that the vehicle is to perform vehicle services for the service entity). For example, the computing system can determine that the vehicle is to solely perform one or more vehicle services for the first service entity during a first time period. This can include the vehicle only accepting vehicle service assignment(s) from the first service entity during the first time period.

The determination of the first service entity from among the plurality of service entities can include the selection of a particular client, platform, network, API, etc. from among a variety of different clients, platforms, networks, APIs, etc. For instance, the computing system can determine a first vehicle client (e.g., software platform) from among a plurality of different vehicle clients (e.g., associated with the different service entities), for the vehicle to utilize. Additionally, or alternatively, the computing system can determine a first computing platform and/or telecommunications network (e.g., of the first service entity) from among a plurality of different computing platform and/or telecommunications networks (e.g., associated with the different service entities), for the vehicle to utilize and/or connect with. Additionally, or alternatively, the computing system can determine a first application programming interface (e.g., of the first service entity) from among a plurality of different application programming interfaces (e.g., associated with the different service entities), for the vehicle to access and/or utilize.

In some implementations, the computing system can weigh the various types of information associated with the plurality of service entities to select the first service entity. For example, the computing system can determine the first service entity by applying at least one of a first weight to route based data, a second weight to capacity data, a third weight to vehicle requirements data, and a fourth weight to safety requirements data. As described herein, one or more of these weights can be the same or different from one another. In some embodiments the data is determined by sensors associated with the autonomous vehicle.

In some implementations, the computing system can weigh the various types of information associated with the plurality of services entities to select the first service entity. For example, the computing system can determine the first service entity by applying at least one of a first weight to the historic vehicle service data, a second weight to the current vehicle service data, a third weight to the vehicle service compensation data, a fourth weight to the future vehicle service data, a fifth weight to the data indicative of the one or more vehicle service quotas, and/or a sixth weight to the data indicative of the one or more vehicle service incentives. As described herein, one or more of these weights can be the same or different from one another.

In some implementations, the computing system (e.g., a vehicle computing system 100) can obtain the data associated with the plurality of service entities from a computing system of a third party associated with the vehicle (e.g., third party computing system 210). For example, the vehicle can be included in a fleet of vehicles (e.g., autonomous vehicles) associated with the third party. Moreover, the vehicle can be included within a subset of the fleet of vehicles that are designated for the first service entity. The data associated with the plurality of service entities can include data identifying a first service entity for the vehicle (e.g., as designated by the third party).

At (715), the method 700 can include indicating to the first service entity that the vehicle is available. For instance, the computing system (e.g., the vehicle computing system 100 onboard the vehicle 105, the third party computing system 210, etc.) can indicate, to a remote computing system associated with the first service entity (e.g., the first operations computing system 225A) that the vehicle is available to perform the first vehicle service for the first service entity (e.g., available to obtain vehicle service assignments, available to transport user(s) and/or item(s) as requested for first service entity). As described herein, this can include going online with the first service entity (e.g., a computing platform, network associated therewith, etc.), establishing a communication session with the first service entity's computing system (e.g., the first operations computing system 225A), directly or indirectly communicating data indicative the vehicle's availability to the first service entity's computing system (e.g., the first operations computing system 225A), and/or other techniques for indicating that the vehicle is available to perform vehicle service(s) for the service entity (e.g., for the associated user(s), etc.).

At (720), the method 700 can include obtaining data indicative of a vehicle service assignment. The computing system (e.g., the vehicle computing system 100 onboard the vehicle 105, the third party computing system 210, etc.) can obtain data indicative of a vehicle service assignment associated with the first service entity. The vehicle service assignment can be indicative of a first vehicle service. For instance, the vehicle service assignment can indicate that the vehicle is to (or is requested to) perform the first vehicle service (e.g., a transportation service) associated with an origin location and a destination location. In some implementations, if permitted, the vehicle service assignment can be indicative of the user that requested the vehicle service and/or other information (e.g., user preferences, service parameters, etc.). The computing system (e.g., the vehicle computing system 100 onboard the vehicle 105, the third party computing system 210, etc.) can communicate data indicative of an acceptance of the vehicle service assignment associated with the first service entity (e.g., to the first operations computing system 225A), at (725).

At (730), the method 700 can include causing the vehicle to initiate a motion control in accordance with the vehicle service assignment. For instance, the computing system (e.g., the vehicle computing system 100 onboard the vehicle 105, the third party computing system 210, etc.) can cause the vehicle to initiate a motion control in accordance with the vehicle service assignment. For example, a third party computing system 210 can communicate (to the vehicle) data indicative of the vehicle service assignment and/or instructions for the vehicle to travel in accordance with the vehicle service assignment (e.g., to travel to an origin location, destination location, along a route, etc.). A vehicle computing system (e.g., an autonomy system) can communicate signals to the control systems of the vehicle to control the motion of the vehicle so that the vehicle travels (e.g., autonomously) to address the vehicle service assignment. As described herein, a vehicle can perform a vehicle service for an entity by performing the vehicle services for the user(s) that request such vehicle services associated with the service entity. This can include the vehicle providing the vehicle services, for example, by travelling to an origin location (e.g., to allow a user to board, to allow an item to be placed into the vehicle, etc.), transporting the user/item to a destination location (e.g., to allow the user to deboard the vehicle, to allow an item to be removed from the vehicle, etc.).

In some implementations, at (735), the method 700 can include determining another service entity for which the vehicle is to perform a vehicle service. For instance, the computing system (e.g., the vehicle computing system 100 onboard the vehicle 105, the third party computing system 210, etc.) can determine a second service entity of the plurality of service entities for which the vehicle is to perform a second vehicle service. The second vehicle service can be the same type or a different type of vehicle service as the first vehicle service (performed for the first service entity). The computing system can indicate, to a second remote computing system associated with the second service entity (e.g., the second operations computing system 225B) that the vehicle is available to perform the second vehicle service for the second service entity (and/or obtain vehicle service assignment(s) form the second service entity), at (740). As described herein, in some implementations, the vehicle can perform vehicle service(s) for the first service entity for a first time period. Accordingly, in some implementations, the vehicle can indicate that the vehicle is available to perform the second vehicle service for the second service entity, after the first time period. The computing system can obtain data indicative of a vehicle service assignment associated with the second service entity and the vehicle can perform the second vehicle service indicated by the vehicle service assignment associated with the second service entity (e.g., a delivery service for the second service entity).

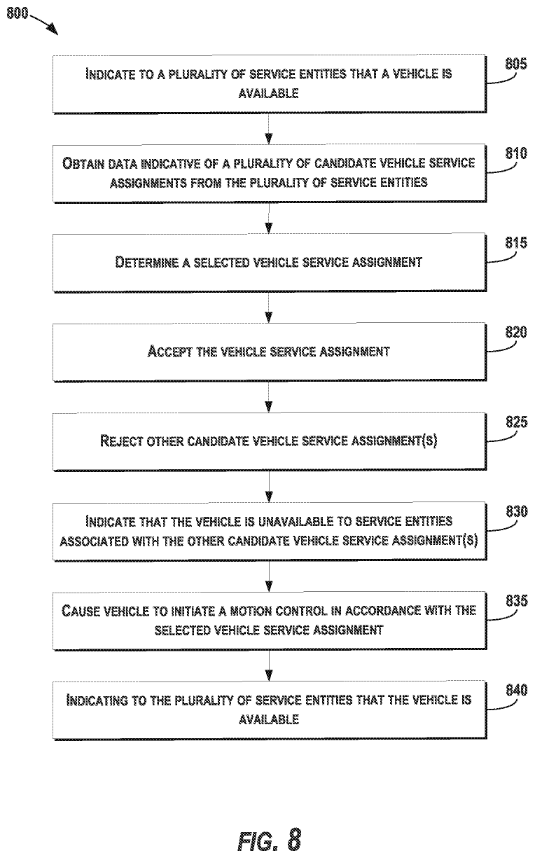

FIG. 8 depicts a flow diagram of another example method for controlling autonomous vehicles according to example embodiments of the present disclosure. One or more portion(s) of the method 800 can be implemented by a computing system that includes one or more computing devices such as, for example, the computing systems described with reference to the other figures (e.g., the vehicle computing system 100, the third party computing system 210, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1, 2, and/or 10), for example, to control one or more vehicles (e.g., autonomous vehicles). FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for example illustrated purposes and is not meant to be limiting. One or more portions of method 800 can be performed additionally, or alternatively, by other systems.

At (805), the method 800 can include indicating to a plurality of service entities that a vehicle is available. For instance, a computing system (e.g., the vehicle computing system 100 onboard the vehicle 105, the third party computing system 210, etc.) can indicate to each of a plurality of service entities that a vehicle (e.g., autonomous vehicle) is available to perform one or more vehicle services. As described herein, this can include launching a vehicle client (e.g., software platform), going online with the plurality of service entities (e.g., the associated computing platforms, network(s), etc.), communicating (e.g., to operations computing systems of the service entities) that the vehicle is available to perform vehicle service(s) (e.g., to autonomously transport user(s)/item(s), etc.). The computing system can indicate that the vehicle is available to perform the vehicle(s) service by establishing a plurality of communication sessions with a plurality of remote computing systems (e.g., operations computing systems). Each remote computing system can be associated with a different service entity of the plurality of service entities (e.g., an associated operations computing systems of the service entity).

At (810), the method 800 can include obtaining data indicative of a plurality of candidate vehicle service assignments from the plurality of service entities. For instance, the computing system (e.g., the vehicle computing system 100, the third party computing system 210, etc.) can obtain data associated with a plurality of candidate vehicle service assignments. Each of the candidate vehicle service assignments can be associated with a different service entity. For example, each of the candidate vehicle service assignments can include a request for the vehicle to perform one or more vehicle services associated with the respective service entity. In an embodiment, the data associated with the plurality of candidate vehicle service assignments is based on physical requirements of the vehicle. In a separate embodiment, the data associated with the plurality of candidate vehicle service assignments can include at least one of data indicative of a compensation parameter for each respective candidate vehicle service assignment, data indicative of one or more locations associated with each respective candidate vehicle service assignment, data indicative of a type of vehicle service associated with each respective vehicle assignment, data indicative of one or more time constraints associated with each respective vehicle assignment, data indicative of an order in which each vehicle service assignment was obtained by the vehicle, data indicative of one or more vehicle service parameters associated with one or more of the vehicle service assignments, or data indicative of one or more vehicle service incentives associated with one or more of the vehicle service assignments. At least a portion of the data associated with the plurality of candidate vehicle service assignments can be stored in a vehicle service assignment queue (e.g., in a memory onboard the vehicle and/or a memory offboard the vehicle), as described herein.

At (815), the method 800 can include determining a selected vehicle service assignment. For instance, the computing system (e.g., the vehicle computing system 100, the third party computing system 210, etc.) can determine a selected vehicle service assignment based at least in part on the data associated with the plurality of candidate vehicle service assignments. In some implementations, the computing system can apply an optimization function to the data associated with the plurality of candidate vehicle service assignments. The optimization function can be configured to identify at least one candidate vehicle service assignment that should be undertaken by the vehicle (e.g., due to a potentially high vehicle efficiency from location proximity, due to a high compensation, etc.), as described herein. This can allow the computing system (e.g., of the vehicle) to select a vehicle service assignment from among a plurality of vehicle service assignments (from different service entities/computing platforms) in real-time.

At (820), the method 800 can include accepting the vehicle service assignment. For instance, the computing system (e.g., the vehicle computing system 100, the third party computing system 210, etc.) can communicate data indicative of an acceptance of the selected vehicle service assignment to a remote computing system associated with the service entity that is associated with the selected vehicle service assignment (e.g., a first service entity). For instance, the computing system can indicate to the service entity associated with the selected vehicle service assignment (e.g., the operations computing system of that service entity) that the vehicle will perform the one or more requested vehicle services of the selected vehicle service assignment.

At (825), the method 800 can include rejecting other candidate vehicle service assignment(s). For instance, the computing system (e.g., the vehicle computing system 100, the third party computing system 210, etc.) can communicate data indicative of one or more rejections of the one or more candidate vehicle service assignments that are not the selected vehicle service assignment. By way of example, the computing system can indicate that the vehicle will not perform the one or more requested vehicle services of those candidate vehicle service assignments (e.g., a candidate service assignment associated with a second service entity). In some implementations, the candidate vehicle services assignments that are not selected by the computing system can be removed from the vehicle service assignment queue. In some implementations, the candidate vehicle services assignments that are not selected by the computing system may remain in the vehicle service assignment queue (e.g., until the vehicle service assignment is accepted by the vehicle, another vehicle, etc.).

Additionally, or alternatively, at (830), the method 800 can include indicating that the vehicle is unavailable to service entities associated with the other candidate vehicle service assignments. For instance, the computing system (e.g., the vehicle computing system 100, the third party computing system 210, etc.) can indicate to each service entity other than the service entity associated with the selected vehicle assignment that the vehicle is unavailable to perform one or more vehicle services (e.g., while the vehicle is addressing the selected vehicle service assignment). This can include going offline with respect to those service entities, changing a status indicator associated with the vehicle (e.g., to an unavailable status, etc.), terminating the communication sessions associated with those services entities, communicating data indicative of the vehicle's unavailability, etc.

At (835), the method 800 can include causing the vehicle to initiate a motion control in accordance with the selected vehicle service assignment. For instance, the computing system (e.g., the vehicle computing system 100, the third party computing system 210, etc.) can cause the vehicle to initiate a motion control in accordance with the selected vehicle service assignment, as described herein. This can allow the vehicle to travel to perform a vehicle service for the service entity. For example, the vehicle can be caused to travel to perform a transportation service to a user by travelling to pick-up the user, transporting the user, and dropping-off the user (e.g., while implementing any other requested parameters).

At (840), the method 800 can include indicating to the plurality of service entities that the vehicle is available. For instance, following completion of the selected vehicle service assignment, the computing system (e.g., the vehicle computing system 100, the third party computing system 210, etc.) can indicate to each service entity of the plurality of service entities that the vehicle is available to perform one or more vehicle services. This can allow the computing system to indicate that the vehicle is again available for vehicle service assignments from the plurality of service entities (e.g., including the service entity associated with the selected vehicle service assignment and/or other different service entities).

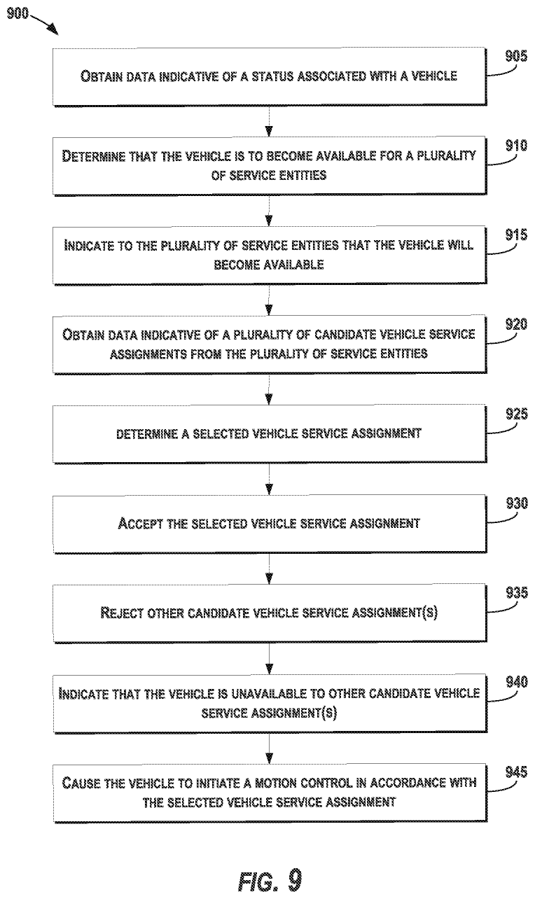

FIG. 9 depicts a flow diagram of an example method for vehicle communication (e.g., autonomous vehicle communication) according to example embodiments of the present disclosure. One or more portion(s) of the method 900 can be implemented by a computing system that includes one or more computing devices such as, for example, the computing systems described with reference to the other figures (e.g., the vehicle computing system 100, the third party computing system 210, etc.). Each respective portion of the method 900 can be performed by any (or any combination) of one or more computing devices. Moreover, one or more portion(s) of the method 900 can be implemented as an algorithm on the hardware components of the device(s) described herein (e.g., as in FIGS. 1, 2, and/or 10), for example, to facilitate communication by a vehicle (e.g., an autonomous vehicle). FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for example illustrated purposes and is not meant to be limiting. One or more portions of method 900 can be performed additionally, or alternatively, by other systems.

At (905), the method 900 can include obtaining data indicative of a status of a vehicle. The computing system (e.g., the vehicle computing system 100, the third party computing system 210, etc.) can obtain data associated with a status of a vehicle (e.g., an autonomous vehicle). For example, the vehicle can be addressing (e.g., providing, performing, travelling for, undergoing, etc.) a current task associated with the vehicle. The current task can include, for example, at least one of receiving maintenance, receiving fuel, charging an electric power source of the autonomous vehicle, and/or addressing a current vehicle service assignment. The status of the vehicle can indicate how long until the current task is complete and/or a progress in the completion of the task.

At (910), the method 900 can include determining that the vehicle is to become available for a plurality of service entities. For instance, the computing system (e.g., the vehicle computing system 100, the third party computing system 210, etc.) can determine that the vehicle is to become available to perform one or more vehicle services at a later time based at least in part on the data associated with the status of the vehicle. This determination can be performed prior to the completion of the current task associated with the vehicle.

The computing system can determine that the vehicle is to become available at the later time based at least in part on the status of the current task associated with the vehicle. By way of example, the current task can include addressing a current vehicle service assignment associated with a first service entity. The computing system can determine how long until the vehicle will complete the current vehicle service assignment. The computing system can estimate that the vehicle will become available to perform one or more vehicle services at a later time that is associated with the completion of the current task (e.g., after completion of the current vehicle service assignment) and/or at a time when the vehicle will be online with one or more service entities.

At (915), the method 900 can include indicating to the plurality of service entities that the vehicle will become available. For instance, the computing system (e.g., the vehicle computing system 100, the third party computing system 210, etc.) can indicate to a plurality of service entities that the vehicle is to become available to perform the one or more vehicle services. As described herein, that can include going online with the service entities, establishing communication sessions, communicating data indicative of the vehicle's availability, etc. In some implementations, this can include an estimated time at which the vehicle will become available.

At (920), the method 900 can include obtaining data indicative of a plurality of candidate vehicle service assignments from the plurality of service entities. For instance, the computing system (e.g., the vehicle computing system 100, the third party computing system 210, etc.) can obtain data associated with a plurality of candidate vehicle service assignments. As described herein, each of the candidate vehicle service assignments can be associated with a different service entity of the plurality of service entities. The computing system can obtain the data associated with the plurality of candidate vehicle service assignments prior to the completion of the current task associated with the vehicle (e.g., prior to completion of a vehicle service assignment, maintenance, re-fueling, etc.).

At (925), the method 900 can include determining a selected vehicle service assignment. For instance, the computing system (e.g., the vehicle computing system 100, the third party computing system 210, etc.) can determine a selected vehicle service assignment based at least in part on the data associated with the plurality of candidate vehicle service assignments, as similarly described herein. The computing system can determine the selected vehicle service assignment prior to completion of the current task associated with the vehicle. This can allow the computing system to pre-emptively select a vehicle service assignment for the vehicle to address before completing a current task (e.g., a current vehicle service assignment). The computing system can accept the selected vehicle service assignment, at (930). For instance, the computing system can communicate data indicative of an acceptance of the selected vehicle service assignment to a remote computing system associated with the service entity that is associated with the selected vehicle service assignment (e.g., to the operations computing system). The computing system can communicate the data indicative of the acceptance prior to completion of the current task associated with the vehicle.

In some implementations, at (935), the method 900 can include rejecting other candidate vehicle assignment(s). For instance, the computing system (e.g., the vehicle computing system 100, the third party computing system 210, etc.) can communicate data indicative of one or more rejections of the one or more candidate vehicle service assignments that are not the selected vehicle service assignment. By way of example, the computing system can indicate that the vehicle will not perform the requested vehicle service(s) of the rejected candidate vehicle service assignments, as described herein. Additionally, or alternatively, at (940), the computing system can indicate to each service entity other than the service entity associated with the selected vehicle assignment that the vehicle is unavailable to perform one or more vehicle services (e.g., while the vehicle is addressing the selected vehicle service assignment), as described herein.

At (945), the method 900 can include causing the vehicle to initiate a motion control in accordance with selected vehicle service assignment. For instance, the computing system (e.g., the vehicle computing system 100, the third party computing system 210, etc.) can cause the vehicle to initiate a motion control in accordance with the selected vehicle service assignment. This can allow the vehicle to travel (e.g., autonomously travel) to perform a vehicle service for the service entity, as described herein.

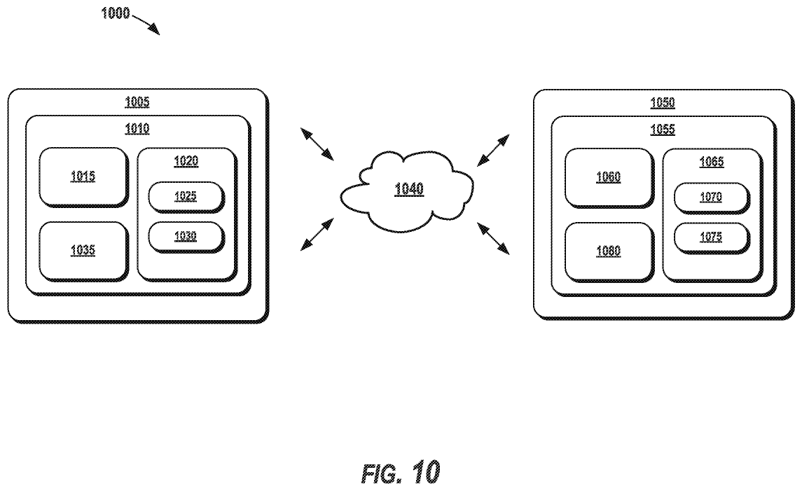

FIG. 10 depicts an example system 1000 according to example embodiments of the present disclosure. The example system 1000 illustrated in FIG. 10 is provided as an example only. The components, systems, connections, and/or other aspects illustrated in FIG. 10 are optional and are provided as examples of what is possible, but not required, to implement the present disclosure. The example system 1005 can include a vehicle computing system 1005 of a vehicle. The vehicle computing system 1005 can represent/correspond to the vehicle computing system 100 described herein. The example system 1000 can include a remote computing system 1050 (e.g., that is remote from the vehicle computing system 1000 of the vehicle). The remote computing system 1050 can represent/correspond to any of operations computing systems (e.g., 225A-B) described herein and/or the third party computing system 210 described herein. These systems can be communicatively coupled to one another over one or more network(s) 1040.

The computing device(s) 1010 of the vehicle computing system 1005 can include processor(s) 1015 and a memory 1020. The one or more processors 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, data registrar, etc., and combinations thereof.

The memory 1020 can store information that can be accessed by the one or more processors 1015. For instance, the memory 1020 (e.g., one or more non-transitory computer-readable storage mediums, memory devices) on-board the vehicle can include computer-readable instructions 1025 that can be executed by the one or more processors 1015. The instructions 1025 can be software written in any suitable programming language or can be implemented in hardware. Additionally, or alternatively, the instructions 1025 can be executed in logically and/or virtually separate threads on processor(s) 1015.

For example, the memory 1020 can store instructions 1025 that when executed by the one or more processors 1015 cause the one or more processors 1015 (the vehicle computing system 1005) to perform operations such as any of the operations and functions of the vehicle computing system 100, any operations and functions of the third party computing system 210 (or for which it is configured), one or more of the operations and functions of the operations computing systems described herein (or for which they are configured), the operations and functions for controlling a vehicle, the operations and functions for selecting a service entity/vehicle service assignment, the operations and functions for communicating vehicle availability to perform vehicle service(s), any of the operations and functions for which the vehicle computing system 100 is configured, one or more portions of the methods 600, 700, 800, and/or 900, and/or any other operations and functions of the vehicle computing systems described herein.

The memory 1020 can store data 1030 that can be obtained (e.g., acquired, received, retrieved, accessed, written, manipulated, created, stored, etc.). The data 1030 can include, for instance, sensor data, map data, vehicle state data, perception data, prediction data, motion planning data, data associated with a vehicle client, data associated with a service entity's telecommunications network, data associated with an API, data associated with a library, data associated with library parameters, data associated with vehicle service assignments, data associated with acceptances and/or rejections of vehicle service assignments, a vehicle service assignment queue, and/or other data/information such as, for example, that described herein. In some implementations, the computing device(s) 1010 can obtain data from one or more memories that are remote from the vehicle computing system 1005.

The computing device(s) 1010 can also include a communication interface 1035 used to communicate with one or more other system(s) on-board a vehicle and/or a remote computing device that is remote from the vehicle (e.g., of the system 1050). The communication interface 1035 can include any circuits, components, software, etc. for communicating via one or more networks (e.g., network(s) 1040). The communication interface 1035 can include, for example, one or more of a communications controller, receiver, transceiver, transmitter, port, conductors, software and/or hardware for communicating data.

The remote computing system 1050 can include one or more computing device(s) 1055 that are remote from the vehicle computing system 1005. The computing device(s) 1055 can include one or more processors 1060 and a memory 1065. The one or more processors 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more tangible, non-transitory computer-readable storage media, such as RAM, ROM, EEPROM, EPROM, one or more memory devices, flash memory devices, data registrar, etc., and combinations thereof

The memory 1065 can store information that can be accessed by the one or more processors 1060. For instance, the memory 1065 (e.g., one or more tangible, non-transitory computer-readable storage media, one or more memory devices, etc.) can include computer-readable instructions 1070 that can be executed by the one or more processors 1060. The instructions 1070 can be software written in any suitable programming language or can be implemented in hardware. Additionally, or alternatively, the instructions 1070 can be executed in logically and/or virtually separate threads on processor(s) 1060.

For example, the memory 1065 can store instructions 1070 that when executed by the one or more processors 1060 cause the one or more processors 1060 to perform operations such as any of the operations and functions of the operations computing systems described herein, any operations and functions of the third party computing system 210, any of the operations and functions for which the operations computing systems and/or the third party computing system 210 are configured, one or more of the operations and functions of the vehicle computing system 100 described herein, the operations and functions for controlling a vehicle, the operations and functions for selecting a service entity/vehicle service assignment, the operations and functions for communicating vehicle availability to perform vehicle service(s), one or more portions of the methods 600, 700, 800, and/or 900, and/or any other operations and functions described herein.

The memory 1065 can store data 1075 that can be obtained. The data 1075 can include, for instance, data associated with service requests, communications associated with/provided by vehicles, data to be communicated to vehicles, application programming interface data, data associated with vehicle service assignments, data associated with acceptances and/or rejections of vehicle service assignments, a vehicle service assignment queue, data associated with a fleet of vehicles, and/or other data/information such as, for example, that described herein. In some implementations, the computing device(s) 1055 can obtain data from one or more memories that are remote from the system 1050 and/or are onboard a vehicle.

The computing device(s) 1055 can also include a communication interface 1080 used to communicate with one or more system(s) onboard a vehicle and/or another computing device that is remote from the system 1050. The communication interface 1080 can include any circuits, components, software, etc. for communicating via one or more networks (e.g., network(s) 1090). The communication interface 1080 can include, for example, one or more of a communications controller, receiver, transceiver, transmitter, port, conductors, software and/or hardware for communicating data.

The network(s) 1040 can be any type of network or combination of networks that allows for communication between devices. In some embodiments, the network(s) 1040 can include one or more of a local area network, wide area network, the Internet, secure network, cellular network, mesh network, peer-to-peer communication link and/or some combination thereof and can include any number of wired or wireless links. Communication over the network(s) 1040 can be accomplished, for instance, via a communication interface using any type of protocol, protection scheme, encoding, format, packaging, etc.

Computing tasks, operations, and functions discussed herein as being performed at the vehicle (e.g., via the vehicle computing system) can instead be performed by computing device(s) that are remote from the vehicle (e.g., a third party computing system, an operations computing system, etc.), and/or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for controlling autonomous vehicles, comprising:
obtaining, by a computing system that comprises one or more computing devices, data associated with a plurality of service entities, wherein each service entity is associated with a provision of one or more vehicle services;
determining, by the computing system and based at least in part on the data associated with the plurality of service entities, a first service entity of the plurality of service entities for which an autonomous vehicle is to perform a first vehicle service;
indicating, by the computing system to a remote computing system associated with the first service entity, that the autonomous vehicle is available to perform the first vehicle service for the first service entity; and
obtaining, by the computing system, data indicative of a vehicle service assignment associated with the first service entity, wherein the vehicle service assignment is indicative of the first vehicle service.
